(19) United States
(12) Patent Application Publication
(10) Pub. No.: US 2006/0208950 A1
(43) Pub. Date: Sep. 21, 2006

(54) Wideband flat antenna

(76) Inventor: Noriyuki Tago, Osaka (JP)

Correspondence Address: MCDERMOTT WILL & EMERY LLP, 600 13TH STREET, N.W., WASHINGTON, DC, 20005-3096, US

(21) Appl. No.: 10/553,638

(22) PCT Filed: Apr. 21, 2004
(86) PCT No.: PCT/JP04/05750

§ 371 Date: Oct. 18, 2005

(30) Foreign Application Priority Data
Apr. 25, 2003 (JP) 2003-121401
Jul. 15, 2003 (JP) 2003-197257

(51) Int. Cl. H01Q 1/24

(52) U.S. Cl. 343/702; 343/700 MS

(57) ABSTRACT

A broad-band plate antenna is configured such that an (N−1)th linear element portion among N linear elements consisting of first to Nth linear element portions has a length longer than an (N−2)th linear element portion, an area of the (N−1)th linear element portion is made larger in a direction of the (N−2)th linear element portion, or in a direction of the Nth linear element portion, or in a direction of the (N−2)th and Nth linear element portions, one feeding point is provided in the Nth linear element portion closest to a groundplate portion, the other feeding point is provided in the (N−1)th linear element portion second closest to the groundplate portion, and an area in the vicinity of a conductive portion of the (N−2)th linear element portion and an area in the vicinity of a conductive portion of the Nth linear element portion closest to the groundplate portion are connected to each other by a first conductor portion.

### TECHNICAL FIELD

The present invention relates to a broad-band plate antenna, and particularly to a broad-band plate antenna structure used within equipment (a portable electronic apparatus such as a notebook personal computer) having a compact size, a small thickness and a limited space.

### BACKGROUND ART

Conventionally, as frequency bands available for a cordless notebook personal computer, for example, 2.4 GHz band in accordance with IEEE 802.11b and 5 GHz band in accordance with IEEE802.11a attaining a transmission speed higher than 2.4 GHz band have been put into practical use. Recently, 2.4 GHz band in accordance with IEEE 802.11g attaining a transmission speed as high as the above-mentioned 5 GHz band has also been available. In addition, in some countries, the 5 GHz band that has already been widely used now covers a broad band including a low frequency and an intermediate frequency around 5 GHz band and a high frequency around 5.8 GHz. That is, there is a growing tendency to cover a broader band and multiband.

As described above, development of a plate antenna suitable for the portable electronic apparatus adapted to both of broad band and multiband has been demanded. Currently, however, practical use or widespread use of a plate antenna adapted to both of the broad band and multiband has not been satisfactory.

FIG. 2 shows a notebook personal computer PC having an antenna attached, implemented by sandwiching a part of a plate antenna 19 in a gap between an liquid crystal (LCD) module 18 and a housing 16 in an upper end portion 15 of a display of notebook personal computer PC and covering the same with a plastic cover 17. In FIG. 2, z1 represents a mount length of a composite element portion when mounted on the notebook personal computer, that corresponds to a length y1 of the composite element portion shown in FIG. 8 which will be described later, for example. Meanwhile, z2 represents a mount length of a groundplate portion when mounted on the notebook personal computer, that corresponds to a length y2 of the groundplate portion shown in FIG. 8.

[Conventional Art 1]

FIG. 3 is an electrically equivalent diagram of a plate inverted-F-type antenna 1 (hereinafter, referred to as an inverted-F-type antenna) according to conventional art 1, as disclosed in Japanese Patent Laying-Open No. 2003-37431. Inverted-F-type antenna 1 has an inverted-F-type antenna groundplate portion 1a and an inverted-F-type antenna linear element portion 1b connected by an inverted-F-type antenna element-to-groundplate short-circuiting portion 1c. A single element feeding point 4 constituted of one feeding point 4a and the other feeding point 4b of a single element signal source 3 is provided on opposing surfaces of an inverted-F-type antenna one-end-open gap portion 1d formed by inverted-F-type antenna groundplate portion 1a and inverted-F-type antenna linear element portion 1b. Plate inverted-F-type antenna 1 is adapted for use for a single frequency.

[Conventional Art 2]

FIG. 4 is an electrically equivalent diagram of a slot antenna 2 according to conventional art 2. Slot antenna 2 has a slot opening portion 2b (a non-conductive portion) formed in a slot conductive portion 2a. Single element feeding point 4 constituted of one feeding point 4c and the other feeding point 4d of single element signal source 3 is provided on opposing surfaces of slot opening portion 2b. Slot antenna 2 is adapted for use for a single frequency.

[Problems to be Solved by First Invention]

As described previously, inverted-F-type antenna 1 in FIG. 3 or slot antenna 2 in FIG. 4 are antennas adapted for use for a single frequency. Accordingly, in order to adapt to frequency bands of both 2.4 GHz band and 5 GHz band, separate antennas for respective frequency bands should be incorporated in an identical portable electronic apparatus. If the antennas are connected for use as a radio unit outputting 2.4 GHz band and 5 GHz band from a single terminal, signals of both frequency bands, i.e., 2.4 GHz band and 5 GHz band, should be combined.

FIG. 5 is a diagram of an antenna multiplexer circuit 8 combining signals from antenna 1 and antenna 2 in order to obtain an output signal equivalent to that of a multiband antenna, and outputting a resultant combined signal to a radio transceiver circuit.

In FIG. 5, in order to obtain an output signal equivalent to that of a multiband antenna, signals from antenna 1 (for example, inverted-F-type antenna 1 according to conventional art 1) and antenna 2 (for example, slot antenna 2 according to conventional art 2) are input to a diplexer unit 7 through connector connection coaxial cables 51, 52 and connectors 61, 62 respectively and combined therein, and the combined signal is output to a radio transceiver circuit through a connector connection coaxial cable 53 and a connector 63. If a divider is used instead of diplexer unit 7, loss is increased.

Antenna multiplexer circuit 8 as described above has the following disadvantages: (1) a plurality of antennas are necessary; (2) diplexer unit 7 or a divider is necessary; and (3) a plurality of coaxial cables and connectors extending from an input of each antenna to an output of the radio transceiver circuit are necessary.

These factors cause significant cost increase and impose restriction on a dimension, a shape, design, or the like of the portable electronic apparatus due to a space for housing these components. In addition, if antenna multiplexer circuit 8 as described above is used for adaption to broader band, in order to combine directivity of the signal from antenna 1 with directivity of the signal from antenna 2, directivity obtained from the output signal from the multiplexer circuit is different from the directivity of the signal from antenna 1 and the directivity of the signal from antenna 2. As a result, originally-intended directivity of each of the signal from antenna 1 and the signal from antenna 2 cannot be obtained.

An object of the first invention is to provide a broad-band plate antenna suitable for a portable electronic apparatus, that can be adapted to broad band and multiband and can obtain originally-intended directivity of a signal from an antenna without increase in cost and restriction on a dimension, a shape, design, or the like of the portable electronic apparatus due to a housing space.

The first invention is directed to an antenna 12 in which a plurality of linear element portions and a slot element portion are integrally formed (hereinafter, referred to as broad-band plate antenna 12) developed by combining an inverted-F-type antenna and a slot antenna according to the conventional art as shown in FIG. 8 as will be described later.

[Problems to be Solved by Second Invention]

When improvement in gain is aimed by forming the broad-band plate antenna in a shape suited to a condition for mount on a portable electronic apparatus, as shown in FIG. 8 which will be described later, in some cases, a linear element portion 22a (hereinafter, referred to as a first linear element portion) in a peripheral portion of the antenna is desirably made shorter than a linear element portion 22b (hereinafter, referred to as a second linear element portion) located on an inner side of first linear element portion 22a. In such a case, however, first linear element portion 22a is less likely to be excited.

Now consider an antenna constituted of a 5 GHz band slot element, a 5 GHz band linear element, and a 2.4 GHz band linear element. Here, first linear element portion 22a has a length longer than second linear element portion 22b. In order for first linear element portion 22a to be more likely to be excited, the 5 GHz band slot element, the 5 GHz band linear element, and the 2.4 GHz band linear element having a length longer than the 5 GHz band linear element are arranged in this order from groundplate portion 21. Since influence by a housing or the like becomes larger as the distance from the housing to each element portion is small, the influence is greatest on the 5 GHz band slot element, second greatest on the 5 GHz band linear element, and least on the 2.4 GHz band linear element. That is, influence is locally exerted on the 5 GHz band.

In order to address this problem, modification in arrangement, that is, arrangement in the order of the 5 GHz band slot element, the 2.4 GHz band linear element, and the 5 GHz band linear element may be possible. In this case, however, first linear element portion 22a is shorter than second linear element portion 22b.

As shown in FIG. 8 which will be described later, excitation of first linear element portion 22a is carried out in the following manner. Initially, second linear element portion 22b is excited. Along with this excitation, electromagnetic field generated in a second one-end-open gap portion 25b serving as a non-conductive portion is coupled from an opening portion of second one-end-open gap portion 25b to an opening portion of a first one-end-open gap portion 25a, to generate electromagnetic field in first one-end-open gap portion 25a, thereby exciting first linear element portion 22a. If second linear element portion 22b is made longer, the opening portions are distant from each other. Then, coupling becomes weaker and first linear element portion 22a is less likely to be excited.

An object of the second invention is to provide a broad-band plate antenna capable of sufficiently exciting a first linear element portion 30a even if first linear element portion 30a is shorter than a second linear element portion 30b so that influence by a housing or the like is not exerted locally on a specific frequency band, in addition to attaining an effect suitable for a portable electronic apparatus that can be adapted to both broad band and multiband and can obtain directivity of a signal from an antenna according to the first invention.

[Problems to be Solved by Third Invention]

An antenna having an unbalanced shape such as an inverted-F-type antenna is generally formed by an element forming portion (plate antenna width a×composite element portion length y1) and groundplate portion 21 (plate antenna width a×groundplate portion length y2). When an area of the element forming portion is small, an area of an element portion (a conductive portion) or an area of a non-conductive portion or a gap portion becomes small. Then, an operation band where operation with necessary reflection loss (return loss) is possible becomes narrower.

If a feeding point forming conductor portion 23 and a slot element-groundplate short-circuiting portion 27 are present between second linear element portion 30b and groundplate portion 21 in FIG. 13 according to the second invention which will be described later, the operation band of second linear element portion 30b becomes narrower. If feeding point forming conductor portion 23 and slot element-groundplate short-circuiting portion 27 are removed, a slot element portion 24 surrounded by these portions disappears.

Alternatively, a third linear element portion 30c is newly provided. Third linear element portion 30c has approximately half the length of slot element portion 24, with respect to the same operation frequency. Therefore, a gap between second linear element portion 30b and groundplate portion 21 is increased, so that the operation band of second linear element portion 30b can be broadened.

As a result, a broad-band plate antenna 20 having a small composite element portion length y1 in FIG. 16 according to the third invention which will be described later can be provided. Composite element portion length y1 corresponds to composite element portion mount length z1 when mounted on a notebook personal computer, and represents a portion that cannot extend along LCD module 18 and housing (metal) 16 if radiation is to be performed. Therefore, if a dimension of these portions is made smaller, a compact notebook personal computer can be provided.

An object of the third invention is to provide a broad-band plate antenna capable of sufficiently exciting first linear element portion 30a even if first linear element portion 30a is shorter than second linear element portion 30b so that influence by a housing or the like is not exerted locally on a specific frequency band, in addition to attaining an effect suitable for a portable electronic apparatus that can be adapted to both broad band and multiband and can obtain directivity of a signal from an antenna according to the first invention, as well as achieving a broader operation band of second linear element portion 30b by increasing an area of second linear element portion 30b and an area of a gap portion between second linear element portion 30b and groundplate portion 21 according to the second invention.

### DISCLOSURE OF THE INVENTION

[Means for Solving Problems According to First Invention]

According to solving means of the first invention, as shown in FIG. 7, there is provided a broad-band plate antenna 11 in which a single linear element portion and a slot element portion are integrally formed, wherein a one-end-open non-conductive surface 25 is provided in a conductive substrate 10 in parallel to a part of an outer perimeter of conductive substrate 10, so as to form a linear element portion 22 between the part of the outer perimeter and one-end-open non-conductive surface 25,

a closed rectangle shaped non-conductive surface is provided in conductive substrate 10 in parallel to one-end-open non-conductive surface 25, so as to form slot element portion 24,

a non-conductive portion 28 is provided in feeding point forming conductive portion 23 formed between one-end-open non-conductive surface 25 and slot element portion 24, so as to use opposing ends of non-conductive portion 28 as a composite element feeding point 14, and

remaining conductive portion of conductive substrate 10 other than linear element portion 22, slot element portion 24, and feeding point forming conductive portion 23 is used as groundplate portion 21.

[Means for Solving Problems According to Second Invention]

According to solving means of the second invention, as shown in FIG. 13, there is provided broad-band plate antenna 12, wherein a first one-end-open non-conductive surface 25a is provided in conductive substrate 10 in parallel to a part of an outer perimeter of conductive substrate 10, so as to form linear element portion 30a (first linear element portion 30a) of which length on an outer peripheral side of conductive substrate 10 is shorter between the part of the outer perimeter and first one-end-open non-conductive surface 25a,

a second one-end-open non-conductive surface 25b is provided in conductive substrate 10 in parallel to first one-end-open non-conductive surface 25a, so as to form linear element 30b (second linear element portion 30b) having a length longer than first linear element portion 30a between second one-end-open non-conductive surface 25b and first one-end-open non-conductive surface 25a,

a closed rectangle shaped non-conductive surface is provided in conductive substrate 10 in parallel to second one-end-open non-conductive surface 25b, so as to form slot element portion 24,

non-conductive portion 28 is provided in feeding point forming conductive portion 23 formed between second linear element portion 30b and slot element portion 24, so as to use opposing ends of non-conductive portion 28 as composite element feeding point 14,

first linear element portion 30a and a feeding point forming conductor portion 23 are provided by a first conductor portion 31, and

remaining conductive substrate 10 other than the plurality of linear element portions, slot element portion 24, and feeding point forming conductive portion 23 is used as groundplate portion 21.

[Means for Solving Problems According to Third Invention]

According to solving means of the third invention, as shown in FIG. 18, there is provided a broad-band plate antenna in which a plurality of linear element portions are integrally formed according to the third invention,

in the plate antenna including conductive substrate 10 forming a composite element portion and groundplate portion 21,

first one-end-open non-conductive surface 25a is provided in conductive substrate 10 in parallel to a part of an outer perimeter of conductive substrate 10, so as to form first linear element portion 30a between the part of the outer perimeter and first one-end-open non-conductive surface 25a,

a second one-end-open non-conductive surface 25b to an Nth one-end-open non-conductive surface 25n are provided in conductive substrate 10 in parallel to first one-end-open non-conductive surface 25a, so as to form second linear element portion 30b to an Nth linear element portion 30n between second one-end-open non-conductive surface 25b and an Nth one-end-open non-conductive surface 25n, an (N−1)th linear element portion 30n-1 second closest to groundplate portion 21 has a length longer than an (N−2)th linear element portion 30n−2 third closest to groundplate portion 21 and Nth linear element portion 30n closest to groundplate portion 21, an area of (N−1)th linear element portion 30n−1 is made larger in a direction of the (N−2)th linear element portion or in a direction of the Nth linear element portion or in the direction of the (N−2)th linear element portion and the direction of the Nth linear element portion, and an area of a non-conductive portion between (N−1)th linear element portion 30n−1 and groundplate portion 21 is made larger,

a conductive portion commonly short-circuiting each element to groundplate portion 21 is identified as an each-element-groundplate commonly short-circuiting conductive portion 26,

one feeding point 14a is provided in the vicinity of each-element-groundplate commonly short-circuiting conductive portion 26 of (N−1)th linear element portion 30n−1,

the other feeding point 14b is provided in the vicinity of each-element-groundplate commonly short-circuiting conductive portion 26 of Nth linear element portion 30n, and

an area in the vicinity of each-element-groundplate commonly short-circuiting conductive portion 26 of (N−2)th linear element portion 30n−2 and an area in the vicinity of each-element-groundplate commonly short-circuiting conductive portion 26 of Nth linear element portion 30n are connected to each other by first conductor portion 31.

All effects of the present invention described hereinafter do not need to be achieved at the same time, and one or more effect of the present invention should only be achieved.

[Effect of First Invention]

An effect of the first invention is as follows. According to a broad-band plate antenna in which a single linear element portion and a slot element portion are integrally formed, a portable electronic apparatus that can be adapted to both broad-band and multiband and can obtain originally-intended directivity of a signal from an antenna can be realized without increase in cost and restriction on a dimension, a shape, design, or the like of the portable electronic apparatus due to a housing space. Different operation frequencies are selected as the operation frequency for the linear element portion and the operation frequency for the slot element portion respectively, so that an element-integrated antenna adapted to two operation frequency bands can be obtained. In addition, adjacent operation frequencies are selected as the operation frequency for the linear element portion and the operation frequency for the slot element portion respectively, so that an element-integrated antenna adapted to continuous and broad operation frequency bands can be obtained.

[Effect of Second Invention]

An effect of the second invention is as follows. In addition to an effect suitable for a portable electronic apparatus that can be adapted to both broad-band and multiband and can obtain directivity of a signal from an antenna according to the first invention, an effect specific to the second invention is that first linear element portion 30a can sufficiently be excited even if first linear element portion 30a is shorter than second linear element portion 30b so that influence by a housing or the like is not exerted locally on a specific frequency band.

[Effect of Third Invention]

An effect of the third invention is as follows. In addition to an effect suitable for a portable electronic apparatus that can be adapted to both broad-band and multiband and can obtain directivity of a signal from an antenna according to the first invention, the third invention can sufficiently excite first linear element portion 30a even if first linear element portion 30a is shorter than second linear element portion 30b so that influence by a housing or the like is not exerted locally on a specific frequency band. Moreover, an effect specific to the third invention is that a broader operation band of the second linear element portion can be obtained by increasing an area of the second linear element portion and an area of a gap portion between the second linear element portion and the groundplate portion.

### BRIEF DESCRIPTION OF THE DRAWINGS

FIG. 1 is an electrically equivalent diagram of a broad-band plate antenna in which a plurality of linear element portions are integrally formed, wherein a second linear element portion has a length longer than a first linear element portion and a third linear element portion, an area is made larger in a direction of the first linear element portion, and a composite element feeding point and a first conductor portion are provided in the linear element portions.

FIG. 2 shows a notebook personal computer having an antenna attached, implemented by sandwiching a part of a groundplate portion of a plate antenna in a gap between a liquid crystal (LCD) module and a housing in an upper end portion of a display of the notebook personal computer and covering the same with a plastic cover.

FIG. 3 is an electrically equivalent diagram of a plate inverted-F-type antenna according to conventional art 1.

FIG. 4 is an electrically equivalent diagram of a slot antenna according to conventional art 2.

FIG. 5 is a diagram of an antenna multiplexer circuit combining signals from antenna 1 and antenna 2 in order to obtain an output signal equivalent to that of a multiband antenna, and outputting a resultant combined signal to a radio transceiver circuit.

FIGS. 6A to 6D are diagrams of feeding line connection showing connection of a feeding line using a sperrtopf for connecting a single feeding line to a feeding point in the electrically equivalent diagram of the plate antenna according to the conventional art.

FIG. 7 is an electrically equivalent diagram of a broad-band plate antenna in which a single linear element portion and a slot element portion are integrally formed according to the first invention.

FIG. 8 is an electrically equivalent diagram of a broad-band plate antenna in which a plurality of linear element portions and a slot element portion are integrally formed, wherein the feeding point according to the first invention is provided in an each-element-groundplate commonly short-circuiting conductive portion and a feeding point forming conductor portion.

FIG. 9 is a first diagram of feeding line connection, in which a feeding line is connected to the feeding point of the broad-band plate antenna in which a single linear element portion and a slot element portion are integrally formed shown in FIG. 7.

FIG. 10 is a second diagram of feeding line connection, in which a feeding line is connected to the feeding point of the broad-band plate antenna in which a single linear element portion and a slot element portion are integrally formed shown in FIG. 7.

FIGS. 11A and 11B are diagrams of feeding line connection in which a feeding line is connected to the feeding point of the broad-band plate antenna shown in FIG. 7 using a sperrtopf adapted to two operation frequencies.

FIG. 12 illustrates a reflection property of the broad-band plate antenna in which a plurality of linear element portions and a slot element portion are integrally formed according to the first invention shown in FIG. 8.

FIG. 13 is an electrically equivalent diagram of the broad-band plate antenna in which a plurality of linear element portions and a slot element portion are integrally formed according to the second invention, wherein the second linear element portion in the broad-band plate antenna in which a plurality of linear element portions and a slot element portion are integrally formed according to the first invention shown in FIG. 8 has a length longer than the first linear element portion, and the feeding point is provided in a protruding portion formed at a connection portion of the each-element-groundplate commonly short-circuiting conductive portion and the second linear element portion and in the feeding point forming conductor portion.

FIG. 14 is an electrically equivalent diagram of the broad-band plate antenna in which a plurality of linear element portions and a slot element portion are integrally formed according to the second invention, wherein the second linear element portion according to the first invention shown in FIG. 8 has a length longer than the first linear element portion, and the feeding point is provided in a protruding portion of the each-element-groundplate commonly short-circuiting conductive portion and in the feeding point forming conductor portion.

FIG. 15 is an electrically equivalent diagram of the broad-band plate antenna in which a plurality of linear element portions and a slot element portion are integrally formed according to the second invention, wherein the second linear element portion according to the first invention shown in FIG. 8 has a length longer than the first linear element portion, and the feeding point according to the second invention is provided in a protruding portion of the second linear element portion and in the feeding point forming conductor portion.

FIG. 16 is an electrically equivalent diagram of a broad-band plate antenna in which a plurality of linear element portions are integrally formed according to the third invention, wherein a composite element portion is formed by the first linear element portion to a third linear element portion, the second linear element portion has a length longer than the first linear element portion and the third linear element portion, the feeding point is provided in the second linear element portion and the third linear element portion, and a first conductor portion is connected to the first linear element portion and the third linear element portion.

FIG. 17 is an electrically equivalent diagram of a broad-band plate antenna in which a plurality of linear element portions are integrally formed according to the third invention, wherein a composite element portion is formed by the first linear element portion to the third linear element portion, the second linear element portion has a length longer than the first linear element portion and the third linear element portion, an area is made larger in a direction of the first linear element portion and in a direction of the third linear element portion, the feeding point is provided in the second linear element portion and the third linear element portion, and the first conductor portion is connected to the first linear element portion and the third linear element portion.

FIG. 18 is an electrically equivalent diagram of a broad-band plate antenna in which a plurality of linear element portions are integrally formed according to the third invention, wherein a composite element portion is formed by the first linear element portion to an Nth linear element portion, an (N−1)th linear element portion has a length longer than an (N−2)th linear element portion and the Nth linear element portion, an area is made larger (a) in a direction of the Nth linear element portion, or (b) in a direction of the (N−2)th linear element portion, or (c) in the direction of the Nth linear element portion and in the direction of the (N−2)th linear element portion, the feeding point is provided in the Nth linear element portion closest to groundplate portion 21 and in the (N−1)th linear element portion second closest to groundplate portion 21, and an area in the vicinity of the each-element-groundplate commonly short-circuiting conductive portion of the (N−2)th linear element portion and an area in the vicinity of the each-element-groundplate commonly short-circuiting conductive portion of the Nth linear element portion closest to groundplate portion 21 are connected by the first conductor portion.

FIG. 19 illustrates a reflection property of the broad-band plate antenna in which a plurality of linear element portions are integrally formed according to the third invention shown in FIG. 1.

### BEST MODE FOR CARRYING OUT THE INVENTION

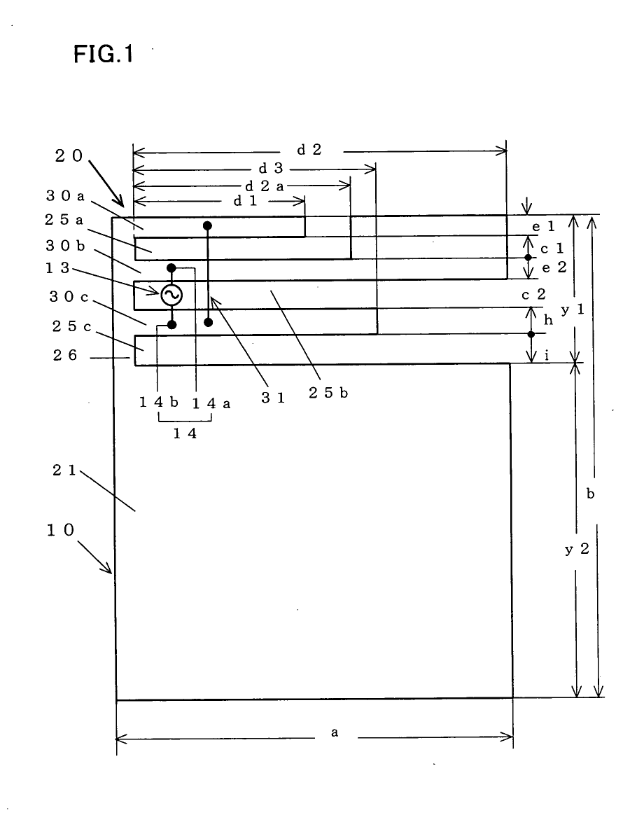

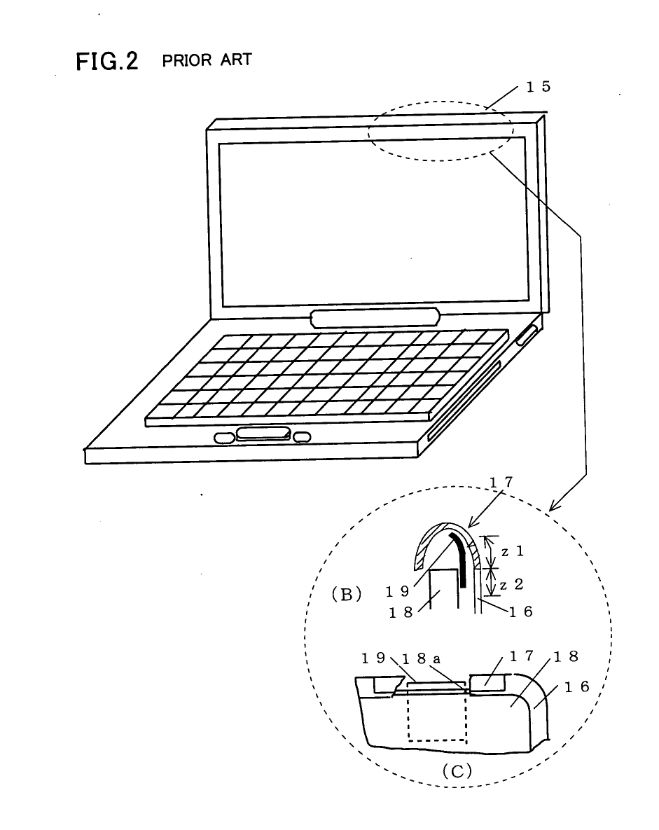

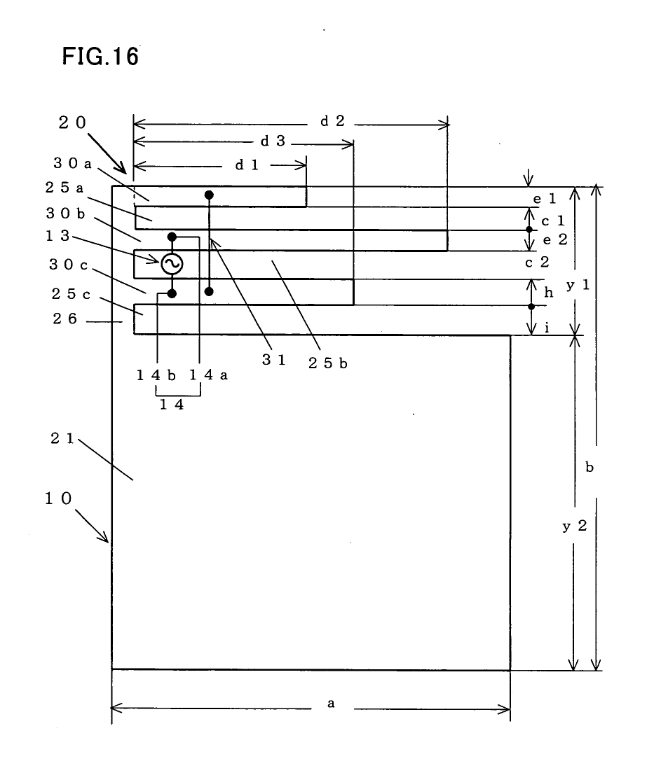

The best mode for carrying out the invention is realized by a broad-band plate antenna in which a plurality of linear element portions are integrally formed according to the third invention, wherein in the composite element portion formed by first linear element portion 30a to third linear element portion 30c shown in FIG. 16 according to the third invention, as shown in FIG. 1, the second linear element portion has a length longer than first linear element portion 30a and third linear element portion 30c, an area of the second linear element portion and an area of a gap portion between the second linear element portion and the groundplate portion is made larger in a direction of first linear element portion 30a, an area of second linear element portion 30b and an area of the gap portion between second linear element portion 30b and groundplate portion 21 are made larger, one feeding point 14a is provided in the vicinity of each-element-groundplate commonly short-circuiting conductive portion 26 of a second linear element portion 30d, the other feeding point 14b is provided in the vicinity of each-element-groundplate commonly short-circuiting conductive portion 26 of third linear element portion 30c, and an area in the vicinity of each-element-groundplate commonly short-circuiting conductive portion 26 of first linear element portion 30a and an area in the vicinity of each-element-groundplate commonly short-circuiting conductive portion 26 of third linear element portion 30c are connected by first conductor portion 31.

### Embodiments Other Than Best Mode

In the following, embodiments for carrying out the invention of the subject application other than the best mode for carrying out the invention described above will be enumerated. The embodiments will be described with reference to the drawings, and the drawings referred to in the embodiments will now be explained.

### Description of the Drawings of Embodiments

FIG. 1 is an electrically equivalent diagram of a broad-band plate antenna in which a plurality of linear element portions are integrally formed, wherein the second linear element portion has a length longer than the first linear element portion and the third linear element portion, an area of second linear element portion 30b and a gap portion between second linear element portion 30b and groundplate portion 21 is made larger in a direction of the first linear element portion, and the composite element feeding point and the first conductor portion are provided in the linear element portions.

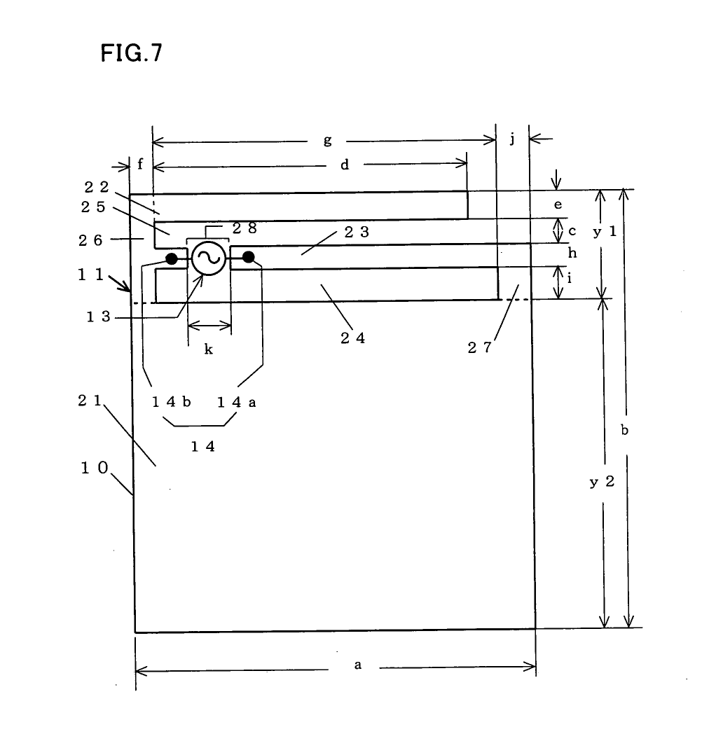

FIG. 7 is an electrically equivalent diagram of the broad-band plate antenna in which a single linear element portion and a slot element portion are integrally formed according to the first invention.

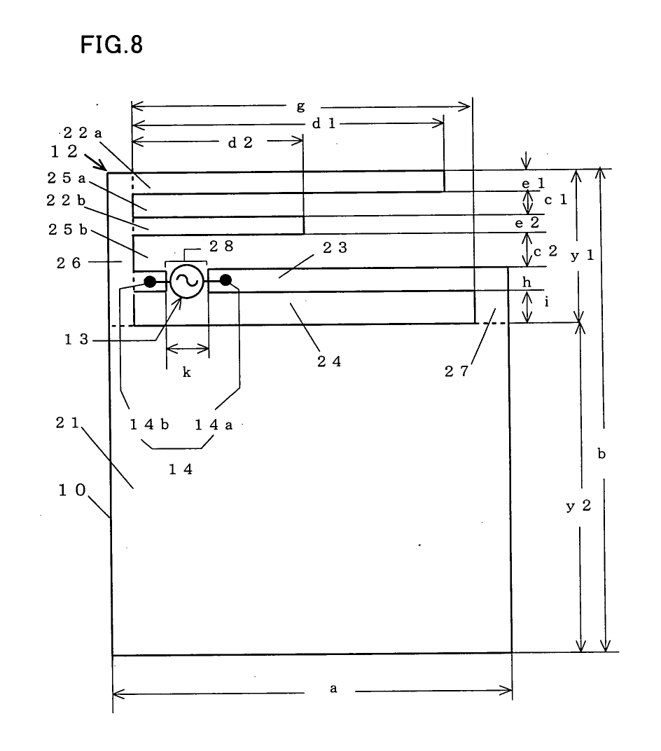

FIG. 8 is an electrically equivalent diagram of the broad-band plate antenna in which a plurality of linear element portions and a slot element portion are integrally formed, wherein the feeding point according to the first invention is provided in a protruding portion of the each-element-groundplate commonly short-circuiting conductive portion and in the feeding point forming conductor portion.

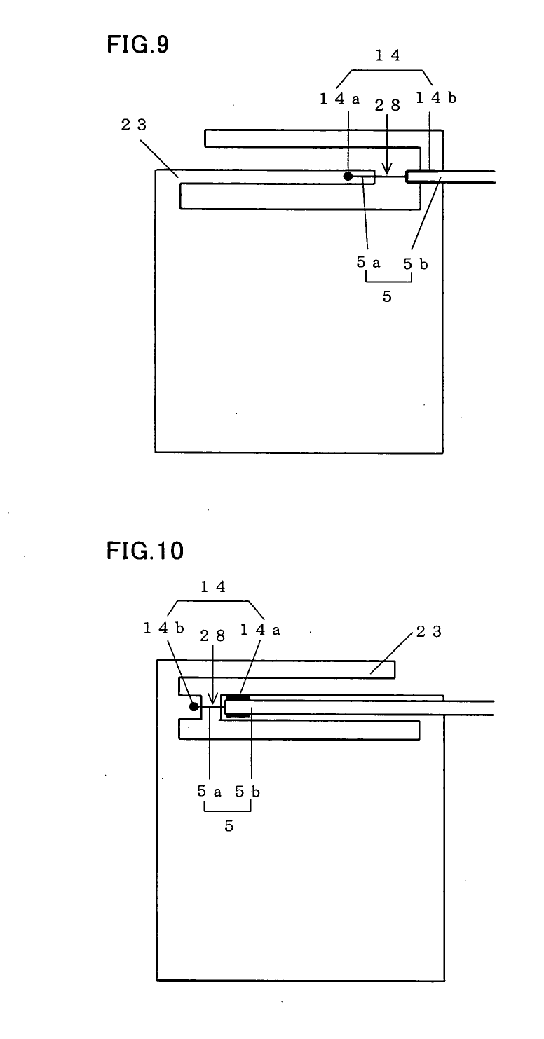

FIG. 9 is a first diagram of coaxial feeding line connection, in which a coaxial feeding line is connected to the feeding point of the broad-band plate antenna in which a single linear element portion and a slot element portion are integrally formed shown in FIG. 7.

FIG. 10 is a second diagram of coaxial feeding line connection, in which a coaxial feeding line is connected to the feeding point of the broad-band plate antenna in which a single linear element portion and a slot element portion are integrally formed shown in FIG. 7.

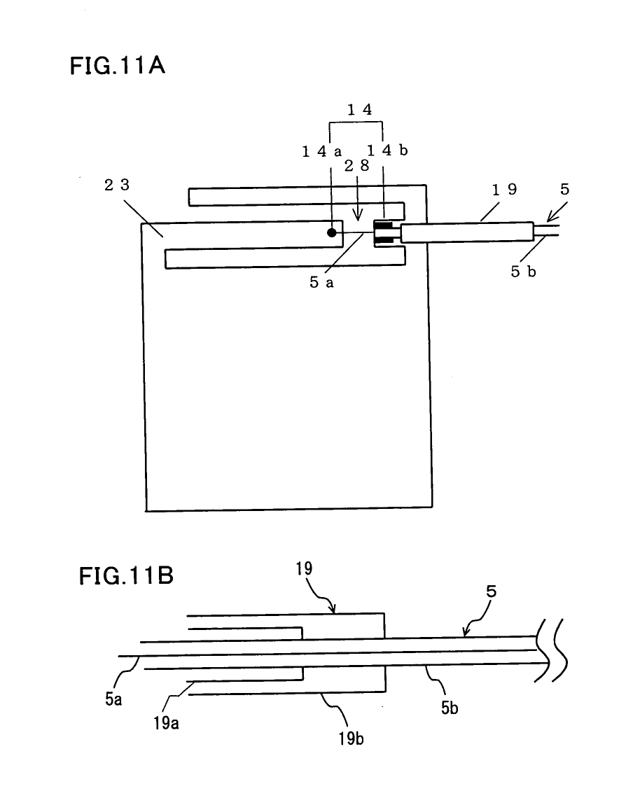

FIGS. 11A and 11B are diagrams of coaxial feeding line connection, in which a coaxial feeding line is connected to the feeding point of the broad-band plate antenna shown in FIG. 7 using a sperrtopf adapted to two operation frequencies.

FIG. 12 illustrates a reflection property of the broad-band plate antenna in which a plurality of linear element portions and a slot element portion are integrally formed according to the first invention shown in FIG. 8.

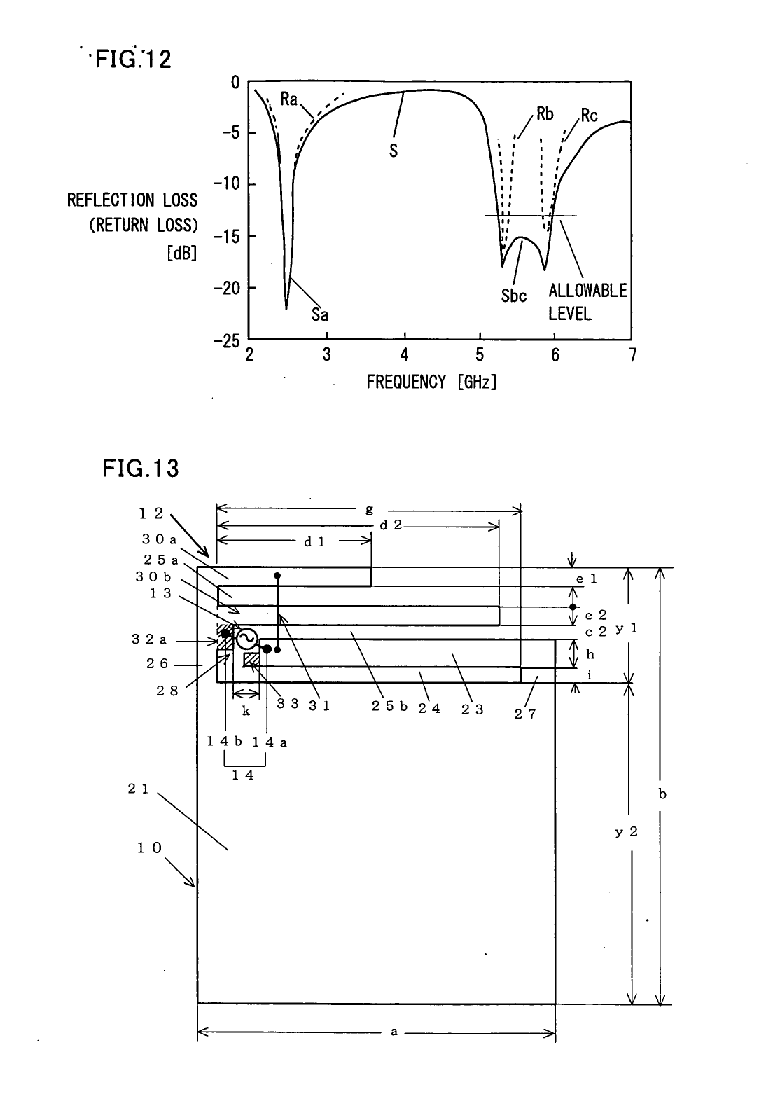

FIG. 13 is an electrically equivalent diagram of a broad-band plate antenna in which a plurality of linear element portions and a slot element portion are integrally formed according to the second invention, wherein the second linear element portion of the antenna according to the first invention shown in FIG. 8 has a length longer than the first linear element portion, and the feeding point is provided in the protruding portion formed at the connection portion of the each-element-groundplate commonly short-circuiting conductive portion and the second linear element portion and in the feeding point forming conductor portion.

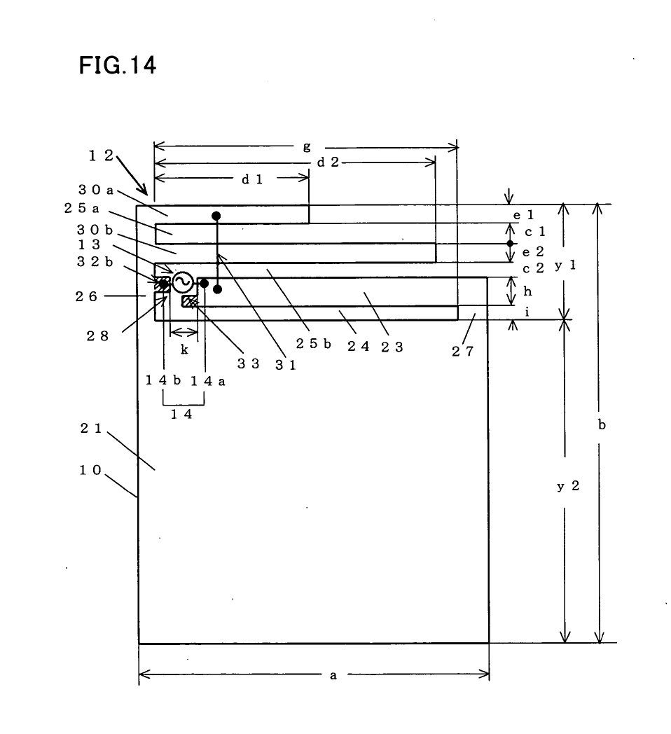

FIG. 14 is an electrically equivalent diagram of the broad-band plate antenna in which a plurality of linear element portions and a slot element portion are integrally formed according to the second invention, wherein the second linear element portion of the antenna according to the first invention shown in FIG. 8 has a length longer than the first linear element portion, and the feeding point is provided in the protruding portion of the each-element-groundplate commonly short-circuiting conductive portion and in the feeding point forming conductor portion.

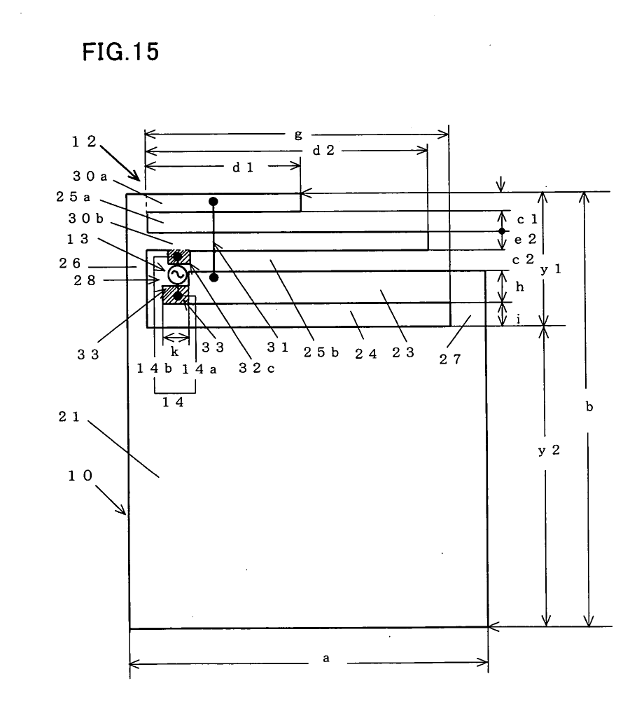

FIG. 15 is an electrically equivalent diagram of the broad-band plate antenna in which a plurality of linear element portions and a slot element portion are integrally formed according to the second invention, wherein the second linear element portion of the antenna according to the first invention shown in FIG. 8 has a length longer than the first linear element portion, and the feeding point according to the second invention is provided in the protruding portion of the second linear element portion and in the feeding point forming conductor portion.

FIG. 16 is an electrically equivalent diagram of a broad-band plate antenna in which a plurality of linear element portions are integrally formed according to the third invention, wherein the composite element portion is formed by the first linear element portion to the third linear element portion, the second linear element portion has a length longer than the first linear element portion and the third linear element portion, the feeding point is provided in the second linear element portion and the third linear element portion, and the first conductor portion is connected to the first linear element portion and the third linear element portion.

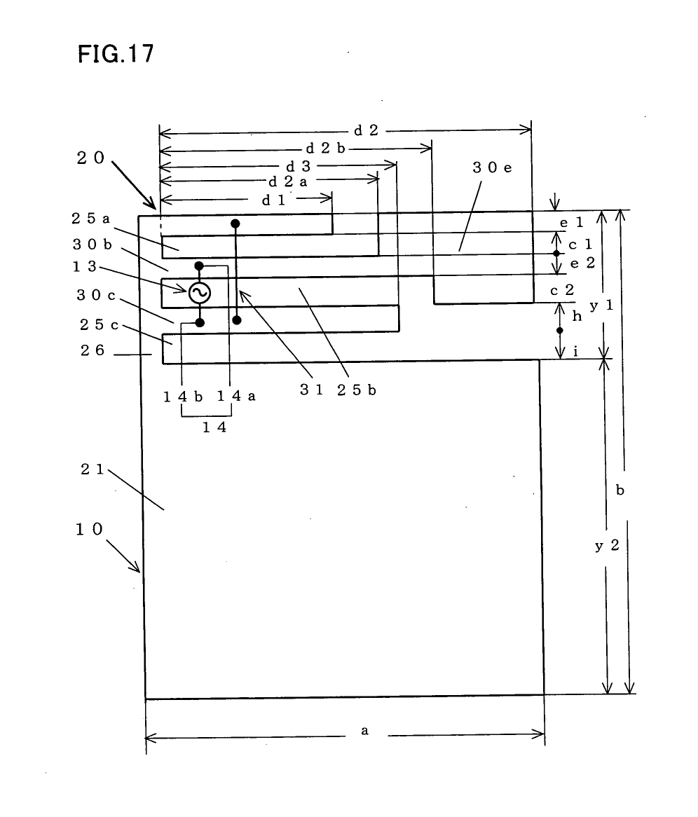

FIG. 17 is an electrically equivalent diagram of a broad-band plate antenna in which a plurality of linear element portions are integrally formed according to the third invention, wherein the composite element portion is formed by the first linear element portion to the third linear element portion, the second linear element portion has a length longer than the first linear element portion and the third linear element portion, an area is made larger in a direction of the first linear element portion and in a direction of the third linear element portion, the feeding point is provided in the second linear element portion and the third linear element portion, and the first conductor portion is connected to the first linear element portion and the third linear element portion.

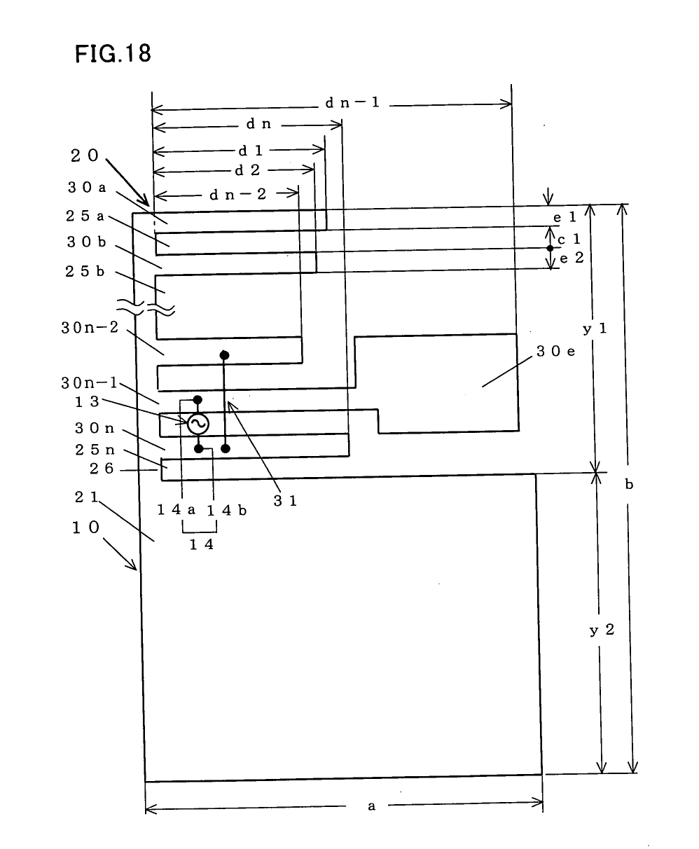

FIG. 18 is an electrically equivalent diagram of a broad-band plate antenna in which a plurality of linear element portions are integrally formed according to the third invention, wherein the composite element portion is formed by the first linear element portion to the Nth linear element portion, (N−1)th linear element portion 30n−1 has a length longer than (N−2)th linear element portion 30n−2 and Nth linear element portion 30n, an area of (N−1)th linear element portion 30n−1 is made larger (a) in a direction of (N−2)th linear element portion 30n−2, or (b) in a direction of Nth linear element portion 30n, or (c) in the direction of (N−2)th linear element portion 30n−2 and in the direction of Nth linear element portion 30n, one feeding point 14a is provided in Nth linear element portion 30n closest to groundplate portion 21, the other feeding point 14b is provided in (N−1)th linear element portion 30n-1 second closest to groundplate portion 21, and an area in the vicinity of each-element-groundplate commonly short-circuiting conductive portion 26 of (N−2)th linear element portion 30n−2 and an area in the vicinity of each-element-groundplate commonly short-circuiting conductive portion 26 of Nth linear element portion 30n closest to groundplate portion 21 are connected by first conductor portion 31.

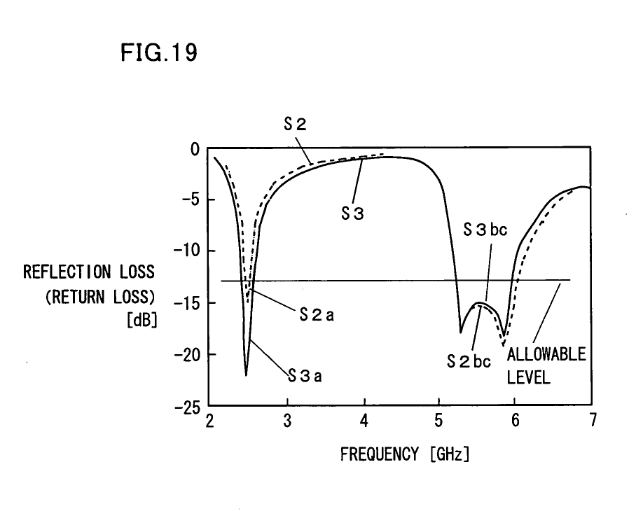

FIG. 19 illustrates a reflection property of the broad-band plate antenna in which a plurality of linear element portions are integrally formed according to the third invention shown in FIG. 1. FIG. 19, similarly to FIG. 12 above, illustrates a reflection property, in which the abscissa represents an operation frequency [GHz] input/output to the feeding point of broad-band plate antenna 20 in which a plurality of linear element portions are integrally formed, while the ordinate represents reflection loss (return loss) [dB] specified by a shape of an antenna for each frequency.

In the following, specific examples obtained by modifying and expanding the means for solving the problems will be shown as embodiments (hereinafter, referred to as an aspect) in a form of claims, with reference to the drawing and reference numerals therein.

[Aspect According to First Invention]

According to the invention in aspect 1, as shown in FIG. 7, there is provided broad-band plate antenna 11 in which a single linear element portion and a slot element portion are integrally formed, wherein one-end-open non-conductive surface 25 is provided in conductive substrate 10 in parallel to a part of the outer perimeter of conductive substrate 10, so as to form linear element portion 22 between the part of the outer perimeter and one-end-open non-conductive surface 25,

a closed rectangle shaped non-conductive surface is provided in conductive substrate 10 in parallel to one-end-open non-conductive surface 25, so as to form slot element portion 24,

non-conductive portion 28 is provided in feeding point forming conductive portion 23 formed between one-end-open non-conductive surface 25 and slot element portion 24, so as to use opposing ends of non-conductive portion 28 as composite element feeding point 14, and

remaining conductive portion of conductive substrate 10 other than linear element portion 22, slot element portion 24, and feeding point forming conductive portion 23 is used as groundplate portion 21.

According to the invention in aspect 2, as shown in FIG. 7, there is provided broad-band plate antenna 11 in which a single linear element portion and a slot element portion are integrally formed, wherein

one-end-open gap portion 25 is provided in conductive substrate 10 in parallel to a part of an outer perimeter of conductive substrate 10, so as to form linear element portion 22 between the part of the outer perimeter and one-end-open gap portion 25,

a slot is provided in conductive substrate 10 in parallel to one-end-open gap portion 25, so as to form slot element portion 24,

opening portion 28 is provided in feeding point forming conductor portion 23 formed between one-end-open gap portion 25 and slot element portion 24, so as to use opposing ends of opening portion 28 as composite element feeding point 14, and

remaining conductive substrate 10 other than linear element portion 22, slot element portion 24, and feeding point forming conductor portion 23 is used as a groundplate portion 21.

[Effect of Aspect 1 and Aspect 2]

According to the broad-band plate antenna in which a single linear element portion and a slot element portion are integrally formed recited in aspects 1 and 2, a portable electronic apparatus that can be adapted to broad-band and multiband and can obtain originally-intended directivity of a signal from an antenna can be realized without increase in cost and restriction on a dimension, a shape, design, or the like of the portable electronic apparatus due to a housing space. Different operation frequencies are selected as the operation frequency for the linear element portion and the operation frequency for the slot element portion respectively, so that an element-integrated antenna adapted to two operation frequency bands can be obtained. In addition, adjacent operation frequencies are selected as the operation frequency for the linear element portion and the operation frequency for the slot element portion respectively, so that an element-integrated antenna adapted to continuous and broad operation frequency bands can be obtained.

According to the invention in aspect 3, as shown in FIG. 8, there is provided broad-band plate antenna 12 in which a plurality of linear element portions and a slot element portion are integrally formed, wherein

first one-end-open non-conductive surface 25a is provided in conductive substrate 10 in parallel to a part of the outer perimeter of conductive substrate 10, so as to form first linear element portion 22a between the part of the outer perimeter and first one-end-open non-conductive surface 25a,

second one-end-open non-conductive surface 25b is provided in conductive substrate 10 in parallel to first one-end-open non-conductive surface 25a, so as to form second linear element portion 22b between second one-end-open non-conductive surface 25b and first one-end-open non-conductive surface 25a,

a closed rectangle shaped non-conductive surface is provided in conductive substrate 10 in parallel to second one-end-open non-conductive surface 25b, so as to form slot element portion 24,

non-conductive portion 28 is provided in feeding point forming conductive portion 23 formed between second linear element portion 22b and slot element portion 24, so as to use opposing ends of non-conductive portion 28 as composite element feeding point 14, and

remaining conductive substrate 10 other than the plurality of linear element portions, slot element portion 24, and feeding point forming conductive portion 23 is used as groundplate portion 21.

According to the invention in aspect 4, as shown in FIG. 8, there is provided broad-band plate antenna 12 in which a plurality of linear element portions and a slot element portion are integrally formed, wherein

first one-end-open gap portion 25a is provided in conductive substrate 10 in parallel to a part of the outer perimeter of conductive substrate 10, so as to form first linear element portion 22a between the part of the outer perimeter and first one-end-open gap portion 25a,

second one-end-open gap portion 25b is provided in conductive substrate 10 in parallel to first one-end-open gap portion 25a, so as to form second linear element portion 22b between second one-end-open gap portion 25b and first one-end-open gap portion 25a,

a slot is provided in conductive substrate 10 in parallel to second one-end-open gap portion 25b, so as to form slot element portion 24,

opening portion 28 is provided in feeding point forming conductor portion 23 formed between second linear element portion 22b and slot element portion 24, so as to use opposing ends of opening portion 28 as composite element feeding point 14, and

remaining conductive substrate 10 other than the plurality of linear element portions, slot element portion 24, and feeding point forming conductor portion 23 is used as groundplate portion 21.

[Effect of Aspect 3 and Aspect 4]

According to the broad-band plate antenna in which a plurality of linear element portions and a slot element portion are integrally formed recited in aspects 3 and 4, a portable electronic apparatus that can be adapted to further broader band and multiband can be realized, as compared with that recited in aspects 1 and 2. Different operation frequencies are selected as the operation frequency for the first linear element portion, the operation frequency for the second linear element portion, and the operation frequency for the slot element portion respectively, so that an element-integrated antenna adapted to three operation frequency bands can be obtained. In addition, adjacent operation frequencies are selected as the operation frequency for the first linear element portion, the operation frequency for the second linear element portion, and the operation frequency for the slot element portion respectively, so that an element-integrated antenna adapted to continuous and broad operation frequency bands can be obtained.

According to the invention recited in aspect 5, there is provided a broad-band plate antenna in which a plurality of linear element portions and a slot element portion are integrally formed, wherein

first one-end-open non-conductive surface 25a is provided in conductive substrate 10 in parallel to a part of the outer perimeter of conductive substrate 10, so as to form first linear element portion 22a between the part of the outer perimeter and first one-end-open non-conductive surface 25a,

a plurality of one-end-open non-conductive surfaces consisting of second one-end-open non-conductive surface 25b to Nth one-end-open non-conductive surface 25n are provided in conductive substrate 10 in parallel to first one-end-open non-conductive surface 25a, so as to form a plurality of linear element portions consisting of second linear element portion 22b to Nth linear element portion 22n between one-end-open non-conductive surfaces,

a closed rectangle shaped non-conductive surface is provided in conductive substrate 10 in parallel to Nth one-end-open non-conductive surface 25n, so as to form slot element portion 24,

non-conductive portion 28 is provided in feeding point forming conductive portion 23 formed between Nth one-end-open non-conductive surface 25n and slot element portion 24, so as to use opposing ends of non-conductive portion 28 as composite element feeding point 14, and

remaining conductive substrate 10 other than the plurality of linear element portions, slot element portion 24, and feeding point forming conductive portion 23 is used as groundplate portion 21.

According to the invention recited in aspect 6, as shown in FIG. 11A, there is provided a broad-band plate antenna, wherein a first cylindrical conductor 19a having a length corresponding to ¼ wavelength of a first operation frequency out of two operation frequencies is disposed on an outer circumference of an external conductor 5b of a coaxial cable, a second cylindrical conductor 19b having a length corresponding to ¼ wavelength of a second operation frequency out of two operation frequencies is disposed on an outer circumference of first cylindrical conductor 19a, and sperrtopf 19 adapted to two operation frequencies and short-circuiting first cylindrical conductor 19a and second cylindrical conductor 19b to external conductor 5b of the coaxial cable is connected to composite element feeding point 14 recited in aspects 1 to 5 according to the first invention.

[Aspect According to Second Invention]

According to the invention recited in aspect 7, as shown in FIG. 13, there is provided broad-band plate antenna 12, wherein first one-end-open non-conductive surface 25a is provided in conductive substrate 10 in parallel to a part of the outer perimeter of conductive substrate 10, so as to form first linear element portion 30a of which length on an outer peripheral side of conductive substrate 10 is shorter between the part of the outer perimeter and first one-end-open non-conductive surface 25a,

second one-end-open non-conductive surface 25b is provided in conductive substrate 10 in parallel to first one-end-open non-conductive surface 25a, so as to form second linear element portion 30b having a length longer than first linear element portion 30a between second one-end-open non-conductive surface 25b and first one-end-open non-conductive surface 25a,

a closed rectangle shaped non-conductive surface is provided in conductive substrate 10 in parallel to second one-end-open non-conductive surface 25b, so as to form slot element portion 24,

non-conductive portion 28 is provided in feeding point forming conductive portion 23 formed between second linear element portion 30b and slot element portion 24, so as to use opposing ends of non-conductive portion 28 as composite element feeding point 14,

first linear element portion 30a and feeding point forming conductor portion 23 are connected to each other by first conductor portion 31, and

remaining conductive substrate 10 other than the plurality of linear element portions, slot element portion 24, and feeding point forming conductive portion 23 is used as groundplate portion 21.

According to the invention recited in aspect 8, as shown in FIG. 13, there is provided broad-band plate antenna 12 in which a plurality of linear element portions and a slot element portion are integrally formed, wherein

first one-end-open gap portion 25a is provided in conductive substrate 10 in parallel to a part of an outer perimeter of conductive substrate 10, so as to form first linear element portion 30a between the part of the outer perimeter and first one-end-* open gap portion 25a,

second one-end-open gap portion 25b is provided in conductive substrate 10 in parallel to first one-end-open gap portion 25a, so as to form second linear element portion 30b having a length longer than first linear element portion 30a between second one-end-open gap portion 25b and first one-end-open gap portion 25a,

a slot is provided in conductive substrate 10 in parallel to second one-end-open gap portion 25b, so as to form slot element portion 24,

opening portion 28 is provided in feeding point forming conductor portion 23 formed between second linear element portion 30b and slot element portion 24, so as to use opposing ends of opening portion 28 as composite element feeding point 14,

first linear element portion 30a and feeding point forming conductor portion 23 are connected to each other by first conductor portion 31, and

remaining conductive substrate 10 other than the plurality of linear element portions, slot element portion 24, and feeding point forming conductor portion 23 is used as groundplate portion 21.

According to the invention recited in aspect 9, there is provided a broad-band plate antenna, wherein

first one-end-open non-conductive surface 25a is provided in conductive substrate 10 in parallel to a part of the outer perimeter of conductive substrate 10, so as to form first linear element portion 30a between the part of the outer perimeter and first one-end-open non-conductive surface 25a,

a plurality of one-end-open non-conductive surfaces consisting of second one-end-open non-conductive surface 25b to Nth one-end-open non-conductive surface 25n are provided in conductive substrate 10 in parallel to first one-end-open non-conductive surface 25a, so as to form a plurality of linear element portions consisting of second linear element portion 30b having a length longer than first linear element portion 30a to Nth linear element portion 22n between one-end-open non-conductive surfaces,

a closed rectangle shaped non-conductive surface is provided in conductive substrate 10 in parallel to Nth one-end-open non-conductive surface 25n, so as to form slot element portion 24,

non-conductive portion 28 is provided in feeding point forming conductive portion 23 formed between Nth one-end-open non-conductive surface 25n and slot element portion 24, so as to use opposing ends of non-conductive portion 28 as composite element feeding point 14,

N−1th linear element portion 30n−1 and feeding point forming conductor portion 23 are connected to each other by first conductor portion 31, and

remaining conductive substrate 10 other than the plurality of linear element portions, slot element portion 24, and feeding point forming conductive portion 23 is used as groundplate portion 21.

According to the invention recited in aspect 10, in FIG. 13, there is provided a broad-band plate antenna in which feeding point 14b of the second linear element portion is provided in a protruding portion formed at a connection portion of each-element-groundplate commonly short-circuiting conductive portion 26 and second linear element portion 30b (a second conductor portion 32a protruding from the element-groundplate short-circuiting connection portion) and feeding point forming conductor portion 23, and one feeding point 14a is provided in feeding point forming conductor portion 23.

According to the invention recited in aspect 11, in FIG. 14, there is provided a broad-band plate antenna in which feeding point 14b of the second linear element portion is provided in a protruding portion of each-element-groundplate commonly short-circuiting conductive portion 26 (a second conductor portion 32b protruding from the each-element-groundplate commonly short-circuiting conductive portion), and one feeding point 14a is provided in feeding point forming conductor portion 23.

According to the invention recited in aspect 12, in FIG. 15, there is provided a broad-band plate antenna in which feeding point 14b of the second linear element portion (the other feeding point 14b) is provided in a protruding portion of second linear element portion 30b (a second conductor portion 32c protruding from the second element portion), and one feeding point 14a is provided in feeding point forming conductor portion 23.

[Aspect According to Third Invention]

According to the invention recited in aspect 13, there is provided a broad-band plate antenna in which a plurality of linear element portions are integrally formed according to the third invention, wherein a composite element portion is formed by first linear element portion 30a to third linear element portion 30c, second linear element portion 30b has a length longer than first linear element portion 30a, an area of second linear element portion 30b and an area of a non-conductive surface between second linear element portion 30b and groundplate portion 21 are made larger by (a) expansion in a direction of first linear element portion 30a, or (b) by expansion in a direction of third linear element portion 30c, or (c) by expansion in the direction of first linear element portion 30a and third linear element portion 30c and by making third linear element portion 30c shorter than second linear element portion 30b,

a conductive portion commonly short-circuiting each element to groundplate portion 21 is identified as each-element-groundplate commonly short-circuiting conductive portion 26, one feeding point 14a is provided in second linear element portion 30b, the other feeding point 14b is provided in third linear element portion 30c, and an area in the vicinity of each-element-groundplate commonly short-circuiting conductive portion 26 of first linear element portion 30a and an area in the vicinity of each-element-groundplate commonly short-circuiting conductive portion 26 of third linear element portion 30c are connected to each other by first conductor portion 31.

According to the invention recited in aspect 14, in FIG. 16, there is provided a broad-band plate antenna in which a plurality of linear element portions are integrally formed according to the third invention, wherein a composite element portion is formed by first linear element portion 30a to third linear element portion 30c, second linear element portion 30b has a length longer than first linear element portion 30a, third linear element portion 30c has a length shorter than second linear element portion 30b, an area of a non-conductive surface between second linear element portion 30b and groundplate portion 21 is made larger, a conductive portion commonly short-circuiting each element to groundplate portion 21 is identified as each-element-groundplate commonly short-circuiting conductive portion 26, one feeding point 14a is provided in second linear element portion 30b, the other feeding point 14b is provided in third linear element portion 30c, and an area in the vicinity of each-element-groundplate commonly short-circuiting conductive portion 26 of first linear element portion 30a and an area in the vicinity of each-element-groundplate commonly short-circuiting conductive portion 26 of third linear element portion 30c are connected to each other by first conductor portion 31.

According to the invention recited in aspect 15, in FIG. 1, there is provided a broad-band plate antenna in which a plurality of linear element portions are integrally formed according to the third invention, wherein a composite element portion is formed by first linear element portion 30a to third linear element portion 30c, second linear element portion 30b has a length longer than first linear element portion 30a, an area of second linear element portion 30b is made larger in a direction of first linear element portion 30a, third linear element portion 30c has a length shorter than second linear element portion 30b, an area of a non-conductive surface between second linear element portion 30b and groundplate portion 21 is made larger, a conductive portion commonly short-circuiting each element to groundplate portion 21 is identified as each-element-groundplate commonly short-circuiting conductive portion 26, one feeding point 14a is provided in second linear element portion 30b, the other feeding point 14b is provided in third linear element portion 30c, and an area in the vicinity of each-element-groundplate commonly short-circuiting conductive portion 26 of first linear element portion 30a and an area in the vicinity of each-element-groundplate commonly short-circuiting conductive portion 26 of third linear element portion 30c are connected to each other by first conductor portion 31.

According to the invention recited in aspect 16, in FIG. 17, there is provided a broad-band plate antenna in which a plurality of linear element portions are integrally formed according to the third invention, wherein a composite element portion is formed by first linear element portion 30a to third linear element portion 30c, second linear element portion 30b has a length longer than first linear element portion 30a, an area of second linear element portion 30b is made larger in a direction of first linear element portion 30a and third linear element portion 30c, third linear element portion 30c has a length shorter than second linear element portion 30b, an area of a non-conductive surface between second linear element portion 30b and groundplate portion 21 is made larger, a conductive portion commonly short-circuiting each element to groundplate portion 21 is identified as each-element-groundplate commonly short-circuiting conductive portion 26, one feeding point 14a is provided in second linear element portion 30b, the other feeding point 14b is provided in third linear element portion 30c, and an area in the vicinity of each-element-groundplate commonly short-circuiting conductive portion 26 of first linear element portion 30a and an area in the vicinity of each-element-groundplate commonly short-circuiting conductive portion 26 of third linear element portion 30c are connected to each other by first conductor portion 31.

According to the invention recited in aspect 17, as shown in FIG. 18, there is provided a broad-band plate antenna including conductive substrate 10 forming the composite element portion and groundplate portion 21, wherein

first one-end-open non-conductive surface 25a is provided in conductive substrate 10 in parallel to a part of the outer perimeter of conductive substrate 10, so as to form first linear element portion 30a between the part of the outer perimeter and first one-end-open non-conductive surface 25a,

second one-end-open non-conductive surface 25b to Nth one-end-open non-conductive surface 25n are provided in conductive substrate 10 in parallel to first one-end-open non-conductive surface 25a, so as to form second linear element portion 30b to Nth linear element portion 30n between second one-end-open non-conductive surface 25b and Nth one-end-open non-conductive surface 25n, (N−1)th linear element portion 30n-1 second closest to groundplate portion 21 has a length longer than (N−2)th linear element portion 30n−2 third closest to groundplate portion 21 and Nth linear element portion 30n closest to groundplate portion 21, an area of (N−1)th linear element portion 30n−1 is made larger in a direction of the (N−2)th linear element portion or in a direction of the Nth linear element portion or in the direction of the (N−2)th linear element portion and the Nth linear element portion, and an area of a non-conductive portion between (N−1)th linear element portion 30n−1 and groundplate portion 21 is made larger,

a conductive portion commonly short-circuiting each element to groundplate portion 21 is identified as each-element-groundplate commonly short-circuiting conductive portion 26,

one feeding point 14a is provided in the vicinity of each-element-groundplate commonly short-circuiting conductive portion 26 of (N−1)th linear element portion 30n−1,

the other feeding point 14b is provided in the vicinity of each-element-groundplate commonly short-circuiting conductive portion 26 of Nth linear element portion 30n, and

an area in the vicinity of each-element-groundplate commonly short-circuiting conductive portion 26 of (N−2)th linear element portion 30n−2 and an area in the vicinity of each-element-groundplate commonly short-circuiting conductive portion 26 of Nth linear element portion 30n are connected to each other by first conductor portion 31.

The plate antenna commonly implemented according to aspects 1 to 17 described above and enhancing the effect obtained from each aspect is as follows.

(1) The broad-band plate antenna in which the feeding point is connected to an internal conductor and an external conductor of a coaxial cable.

(2) The broad-band plate antenna in which the feeding point is connected to an internal conductor and an external conductor of a coaxial cable to which a sperrtopf is applied.

(3) The broad-band plate antenna having a sperrtopf adapted to two operation frequencies, in which a first cylindrical conductor having a length corresponding to ¼ wavelength of a first operation frequency out of two operation frequencies is disposed on an outer circumference of an external conductor of the coaxial cable, a second cylindrical conductor having a length corresponding to ¼ wavelength of a second operation frequency out of two operation frequencies is disposed outside the first cylindrical conductor, and the sperrtopf short-circuits the first cylindrical conductor and the second cylindrical conductor to the external conductor of the coaxial cable.

### EXAMPLE

### Example 1

### According to First Invention

In the following, a structure of the example according to the first invention will be described with reference to the drawings. Example 1 according to the first invention represents a broad-band plate antenna in which a single linear element portion and a slot element portion are integrally formed. FIG. 7 is an electrically equivalent diagram of the broad-band plate antenna in which a single linear element portion and a slot element portion are integrally formed according to the first invention.

Broad-band plate antenna 11 in which a single linear element portion and a slot element portion are integrally formed shown in FIG. 7 is structured in the following manner.

(1) One-end-open non-conductive surface 25 is provided in conductive substrate 10 in parallel to a part of the outer perimeter of conductive substrate 10, so as to form linear element portion 22 between the part of the outer perimeter and one-end-open non-conductive surface 25,

(2) a closed rectangle shaped non-conductive surface is provided in conductive substrate 10 in parallel to one-end-open non-conductive surface 25, so as to form slot element portion 24,

(3) non-conductive portion 28 is provided in feeding point forming conductive portion 23 formed between one-end-open non-conductive surface 25 and slot element portion 24, so as to use opposing ends of non-conductive portion 28 as composite element feeding point 14, and

(4) remaining conductive portion of conductive substrate 10 other than linear element portion 22, slot element portion 24, and feeding point forming conductive portion 23 is used as groundplate portion 21.

In the structure described above, one-end-open non-conductive surface 25 or slot element portion 24 may be formed by cutting and removing the conductor, or alternatively, the non-conductive surface may be formed by etching away the conductive surface of conductive substrate 10 or by not coating a conductive-film-coat-substrate with a conductive film when it is fabricated.

Antenna 11 in which a single linear element portion and a slot element portion are integrally formed, wherein one-end-open gap portion 25 or slot element portion 24 is formed by using a conductor for conductive substrate 10 and cutting and removing the conductor, is structured in the following manner.

(1) One-end-open gap portion 25 is provided in conductive substrate 10 in parallel to a part of the outer perimeter of conductive substrate 10, so as to form linear element portion 22 between the part of the outer perimeter and one-end-open gap portion 25,

(2) a slot is provided in conductive substrate 10 in parallel to one-end-open gap portion 25, so as to form slot element portion 24,

(3) opening portion 28 is provided in feeding point forming conductor portion 23 formed between one-end-open gap portion 25 and slot element portion 24, so as to use opposing ends of opening portion 28 as composite element feeding point 14, and

(4) remaining conductive substrate 10 other than linear element portion 22, slot element portion 24, and feeding point forming conductor portion 23 is used as groundplate portion 21.

### Example 2

### According to First Invention

Example 2 according to the first invention represents the broad-band plate antenna in which a plurality of linear element portions and a slot element portion are integrally formed, wherein two linear element portions in Example 1 are provided. FIG. 8 electrically illustrates the broad-band plate antenna in which a plurality of linear element portions and a slot element portion are integrally formed according to the first invention.

Antenna 12 in which a plurality of linear element portions and a slot element portion are integrally formed shown in FIG. 8 is structured in the following manner.

(1) First one-end-open non-conductive surface 25a is provided in conductive substrate 10 in parallel to a part of the outer perimeter of conductive substrate 10, so as to form first linear element portion 22a between the part of the outer perimeter and first one-end-open non-conductive surface 25a,

(2) second one-end-open non-conductive surface 25b is provided in conductive substrate 10 in parallel to first one-end-open non-conductive surface 25a, so as to form second linear element portion 22b between second one-end-open non-conductive surface 25b and first one-end-open non-conductive surface 25a,

(3) a closed rectangle shaped non-conductive surface is provided in conductive substrate 10 in parallel to second one-end-open non-conductive surface 25b, so as to form slot element portion 24,

(4) non-conductive portion 28 is provided in feeding point forming conductive portion 23 formed between second linear element portion 22b and slot element portion 24, so as to use opposing ends of non-conductive portion 28 as composite element feeding point 14, and

(5) remaining conductive substrate 10 other than the two linear element portions, slot element portion 24, and feeding point forming conductive portion 23 is used as groundplate portion 21.

Antenna 12 in which a plurality of linear element portions and a slot element portion are integrally formed, wherein one-end-open gap portion 25 or slot element portion 24 is formed by using a conductor for conductive substrate 10 and cutting and removing the conductor, is structured in the following manner.

(1) First one-end-open gap portion 25a is provided in conductive substrate 10 in parallel to a part of the outer perimeter of conductive substrate 10, so as to form first linear element portion 22a between the part of the outer perimeter and first one-end-open gap portion 25a,

(2) second one-end-open gap portion 25b is provided in conductive substrate 10 in parallel to first one-end-open gap portion 25a, so as to form second linear element portion 22b between second one-end-open gap portion 25b and first one-end-open gap portion 25a,

(3) a slot is provided in conductive substrate 10 in parallel to second one-end-open gap portion 25b, so as to form slot element portion 24,

(4) opening portion 28 is provided in feeding point forming conductor portion 23 formed between second linear element portion 22b and slot element portion 24, so as to use opposing ends of opening portion 28 as composite element feeding point 14, and

(5) remaining conductive substrate 10 other than the two linear element portions, slot element portion 24, and feeding point forming conductor portion 23 is used as groundplate portion 21.

### Example 3

### According to First Invention

Not-shown Example 3 according to the first invention represents the broad-band plate antenna in which a plurality of linear element portions and a slot element portion are integrally formed, wherein two linear element portions in Example 2 are replaced with three or more linear element portions. As this plate antenna is similar to that in Example 2, description thereof will not be provided.

In the first invention including Examples 1 to 3 described above, examples of antenna 11 in which a single linear element portion and a slot element portion are integrally formed shown in FIG. 7, antenna 12 in which two linear element portions and a slot element portion are integrally formed shown in FIG. 8, and the antenna in which a plurality of linear element portions and a slot element portion are integrally formed are susceptible to various modifications. The outer perimeter of conductive substrate 10 refers to an outer perimeter of the conductor before the conductor is worked, i.e., cut and removed. Normally, its shape is rectangular or square, however, in addition to straight perimeter, the outer perimeter may partially or entirely be curved. A part of the outer perimeter of conductive substrate 10 normally represents one side of four sides of a rectangle or a square, however, it may be a part of the outer perimeter including a curve.

Plate inverted-F-type antenna 1 which is a modification of what is called a monopole antenna is formed by linear element portion 22 or groundplate portion 21, or first linear element portion 22a, second linear element portion 22b, and groundplate portion 21, so that both of the linear element portion and slot element portion 24 can simultaneously be excited. The linear element portion and slot element portion 24 function at different operation frequency bands.

In the example shown in FIG. 7, antenna 11 in which a single linear element portion and a slot element portion are integrally formed is assumed to have a rectangular shape, and its dimension is assumed as follows. Specifically, a: a length in a direction in parallel to the linear element portion and the slot element portion of conductive substrate 10; b: a length in a direction orthogonal to the linear element portion and the slot element portion of conductive substrate 10; c: a width of one-end-open gap portion 25: d: a length of linear element portion 22; e: a width of linear element portion 22; f: a width of each-element-groundplate commonly short-circuiting conductive portion 26; g: a length of slot element portion 24; h: a width of feeding point forming conductor portion 23; i: a width of slot element portion 24; j: a width of a slot element-groundplate short-circuiting portion 27; k: a length of opening portion 28; y1: a length of the composite element portion; and y2: a length of the groundplate portion.

In antenna 11 in which a single linear element portion and a slot element portion are integrally formed described above, length d of linear element portion 22 is odd multiple of approximately ¼ wavelength of the operation frequency. Length g of slot element portion 24 is integer multiple of approximately ½ wavelength of the operation frequency. Different operation frequencies are selected as the operation frequency for linear element portion 22 and the operation frequency for slot element portion 24 respectively, so that an element-integrated antenna adapted to two operation frequency bands can be obtained. In addition, adjacent operation frequencies are selected as the operation frequency for linear element portion 22 and the operation frequency for slot element portion 24 respectively, so that an element-integrated antenna adapted to continuous and broad operation frequency bands can be obtained.

In the example shown in FIG. 8, antenna 12 in which a plurality of linear element portions and a slot element portion are integrally formed is assumed to have a rectangular shape, and a dimension not used in element-integrated antenna 11 is assumed as follows: c1: a width of first one-end-open gap portion 25a; c2: a width of second one-end-open gap portion 25b; d1: a length of first linear element portion 22a; d2: a length of second linear element portion 22b; e1: a width of first linear element portion 22a; e2: a width of second linear element portion 22b; y1; a length of the composite element portion; and y2: a length of groundplate portion.

In broad-band plate antenna 12 in which a plurality of linear element portions and a slot element portion are integrally formed described above as well, length d1 of first linear element portion 22a and length d2 of second linear element portion 22b are odd multiple of approximately ¼ wavelength of the operation frequency. Length g of slot element portion 24 is integer multiple of approximately ½ wavelength of the operation frequency. Different operation frequencies are selected as the operation frequency for first linear element portion 22a, the operation frequency for second linear element portion 22b and the operation frequency for slot element portion 24 respectively, so that an element-integrated antenna adapted to three operation frequency bands can be obtained. In addition, adjacent operation frequencies are selected as the operation frequency for first linear element portion 22a, the operation frequency for second linear element portion 22b and the operation frequency for slot element portion 24 respectively, so that an element-integrated antenna adapted to continuous and broad operation frequency bands can be obtained.

FIG. 9 is a first diagram of feeding line connection, in which a feeding line is connected to the feeding point of the broad-band plate antenna in which a single linear element portion and a slot element portion are integrally formed according to the first invention shown in FIG. 7. In FIG. 9, one feeding point 14a (a soldered portion 14a of internal conductor 5a) of composite element feeding point 14 of opening portion 28 of feeding point forming conductor portion 23 is connected to internal conductor 5a of the coaxial cable, and the other feeding point 14b (a soldered portion 14b of external conductor 5b) is connected to external conductor 5b of the coaxial cable. The other end of coaxial cable 5 is connected to a not-shown radio transceiver circuit.

FIG. 10 is a second diagram of feeding line connection, in which a feeding line is connected to the feeding point of the broad-band plate antenna in which a single linear element portion and a slot element portion are integrally formed according to the first invention shown in FIG. 7. As in FIG. 9, coaxial cable 5 is connected to composite element feeding point 14 and the radio transceiver circuit.

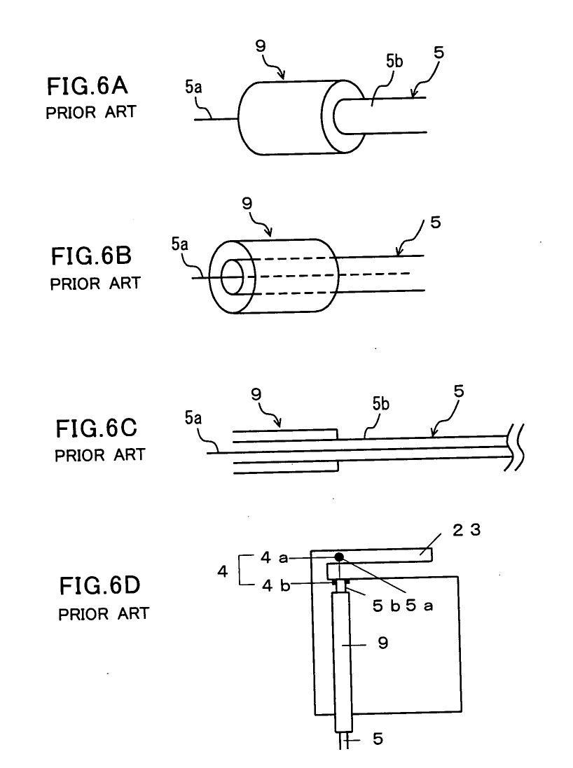

FIG. 6D is a diagram of feeding line connection, in which a feeding line is connected to the feeding point in the electrically equivalent diagram of the plate antenna according to the conventional art by using the sperrtopf for connecting a single feeding line. Sperrtopf 9 refers to a cylindrical conductor for preventing unnecessary current generated on the outer surface of external conductor 5b from a point where external conductor 5b of coaxial cable 5 is provided at feeding point 4 along external conductor 5b. FIG. 6A shows appearance when the sperrtopf is attached to the coaxial cable, FIG. 6B illustrates a structure, and FIG. 6C shows a cross-sectional view.

FIG. 11A is a diagram of feeding line connection, in which a feeding line is connected to the feeding point of the broad-band plate antenna according to the first invention shown in FIG. 7 by using the sperrtopf adapted to two operation frequencies.

Sperrtopf 19 adapted to two operation frequencies shown in FIG. 1I B refers to a cylindrical conductor for preventing unnecessary current generated on the outer surface of external conductor 5b from a point where external conductor 5b of coaxial cable 5 is connected to feeding point 14b along external conductor 5b, wherein first cylindrical conductor 19a having a length corresponding to ¼ wavelength of a first operation frequency out of two operation frequencies is disposed on the outer circumference of external conductor 5b of the coaxial cable, second cylindrical conductor 19b having a length corresponding to ¼ wavelength of a second operation frequency out of two operation frequencies is disposed on the outer circumference of first cylindrical conductor 19a, and the sperrtopf connects first cylindrical conductor 19a and second cylindrical conductor 19b to external conductor 5b of the coaxial cable.

FIG. 11B has shown the sperrtopf adapted to two operation frequencies provided at the feeding point in the electrically equivalent diagram of the broad-band plate antenna in which a single linear element portion and a slot element portion are integrally formed according to the first invention shown in FIG. 7. In the sperrtopf adapted to three operation frequencies at the feeding point in the electrically equivalent diagram of the broad-band plate antenna in which a plurality of linear element portions and a slot element portion are integrally formed according to the first invention shown in FIG. 8, however, a third cylindrical conductor may be provided in addition to first cylindrical conductor 19a and second cylindrical conductor 19b, and these three cylindrical conductors may be coaxially superposed and each connected to external conductor 5b of the coaxial cable.

FIG. 12 illustrates a reflection property of broad-band plate antenna 12 in which a plurality of linear element portions and a slot element portion are integrally formed according to the first invention shown in FIG. 8. FIG. 12 illustrates a reflection property, in which the abscissa represents an operation frequency [GHz] input/output to the feeding point of the broad-band plate antenna in which a plurality of linear element portions and a slot element portion are integrally formed, while the ordinate represents reflection loss (return loss) [dB] specified by a shape of an antenna for each frequency. In FIG. 12, a solid line S represents a reflection property of broad-band plate antenna 12 in which a plurality of linear element portions and a slot element portion are integrally formed according to the first invention shown in FIG. 8.

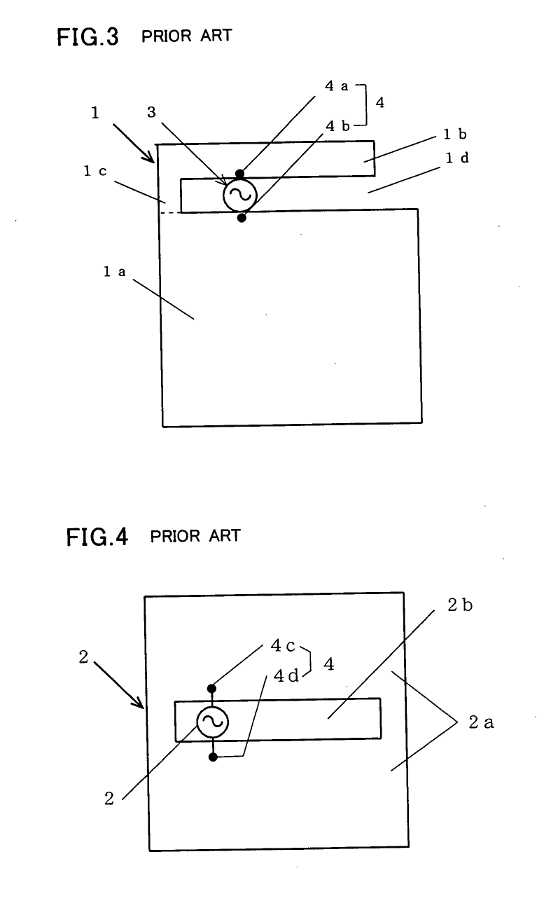

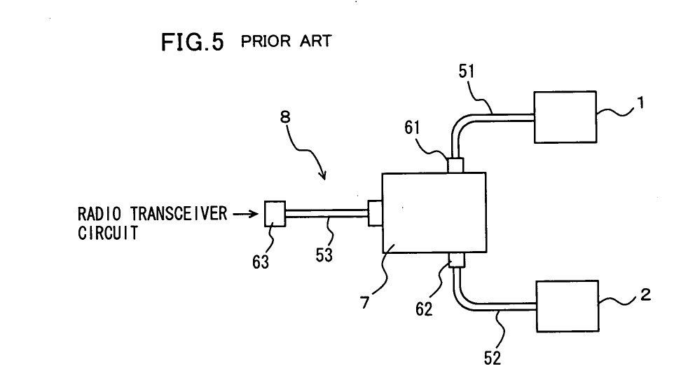

FIG. 12 compares, in dotted lines, (a) reflection property Ra when a dimension of linear element portion 1b of inverted-F-type antenna 1 according to conventional art 1 shown in FIG. 3 is adapted to a dimension of first linear element portion 22a of the element-integrated antenna according to the first invention, (b) reflection property Rb when a dimension of linear element portion 1b of plate inverted-F-type antenna 1 according to conventional art 1 is adapted to a dimension of second linear element portion 22b of the element-integrated antenna according to the first invention, and (c) reflection property Rc when a dimension of slot antenna slot opening portion 2b according to conventional art 2 shown in FIG. 4 is adapted to a dimension of slot element portion 24 of the element-integrated antenna according to the first invention.

A section of property Sbc shown in FIG. 12 represents the property obtained by contribution mainly of second linear element portion 22b and slot element portion 24 of the element-integrated antenna in FIG. 8. The operation frequencies are brought closer to each other, so that the frequency band in which reflection loss is lower than allowable level can considerably be broader than the total of individual frequency bands exhibiting properties Rb and Rc of the antenna according to the conventional art, as shown in FIG. 12.

### Example 4

### According to Second Invention

FIG. 13 shows Example 4 according to the second invention. FIG. 13 is an electrically equivalent diagram of the broad-band plate antenna in which a plurality of linear element portions and a slot element portion are integrally formed, wherein opening portion 28 is provided in feeding point forming conductor portion 23 so that a protruding portion is formed at a connection portion of each-element-groundplate commonly short-circuiting conductive portion 26 and second linear element portion 30b (second conductor portion 32a protruding from the element-groundplate short-circuiting connection portion), the other feeding point 14b is provided in second conductor portion 32a protruding from the element-groundplate short-circuiting connection portion, and one feeding point 14a is provided in feeding point forming conductor portion 23.

Broad-band plate antenna 12 shown in FIG. 13 is structured in the following manner.

(1) First one-end-open non-conductive surface 25a is provided in conductive substrate 10 in parallel to a part of the outer perimeter of conductive substrate 10, so as to form first linear element portion 30a between the part of the outer perimeter and first one-end-open non-conductive surface 25a,

(2) second one-end-open non-conductive surface 25b is provided in conductive substrate 10 in parallel to first one-end-open non-conductive surface 25a, so as to form second linear element portion 30b having a length longer than first linear element portion 30a between second one-end-open non-conductive surface 25b and first one-end-open non-conductive surface 25a,

(3) a closed rectangle shaped non-conductive surface is provided in conductive substrate 10 in parallel to second one-end-open non-conductive surface 25b, so as to form slot element portion 24,

(4) non-conductive portion 28 is provided in feeding point forming conductive portion 23 formed between second linear element portion 30b and slot element portion 24, so as to use opposing ends of non-conductive portion 28 as composite element feeding point 14,

(5) first linear element portion 30a and feeding point forming conductor portion 23 are connected to each other by first conductor portion 31, and

(6) remaining conductive substrate 10 other than the two linear element portions, slot element portion 24, and feeding point forming conductive portion 23 is used as groundplate portion 21.

In FIG. 13, broad-band plate antenna 12, in which one-end-open gap portion 25 or slot element portion 24 is formed by using a conductor for conductive substrate 10 and cutting and removing the conductor, is structured in the following manner.

(1) First one-end-open gap portion 25a is provided in conductive substrate 10 in parallel to a part of the outer perimeter of conductive substrate 10, so as to form first linear element portion 30a between the part of the outer perimeter and first one-end-open gap portion 25a,

(2) second one-end-open gap portion 25b is provided in conductive substrate 10 in parallel to first one-end-open gap portion 25a, so as to form second linear element portion 30b having a length longer than first linear element portion 30a between second one-end-open gap portion 25b and first one-end-open gap portion 25a,

(3) a slot is provided in conductive substrate 10 in parallel to second one-end-open gap portion 25b, so as to form slot element portion 24,

(4) opening portion 28 is provided in feeding point forming conductor portion 23 formed between second linear element portion 30b and slot element portion 24, so as to use opposing ends of opening portion 28 as composite element feeding point 14,

(5) first linear element portion 30a and feeding point forming conductor portion 23 are connected to each other by first conductor portion 31, and

(6) remaining conductive substrate 10 other than the two linear element portions, slot element portion 24, and feeding point forming conductor portion 23 is used as groundplate portion 21.

In FIG. 13, a dimension of broad-band plate antenna 12 is assumed as follows. Specifically, a: a length in a direction in parallel to the linear element portion and the slot element portion of conductive substrate 10; b: a length in a direction orthogonal to the linear element portion and the slot element portion of conductive substrate 10; c1: a width of first one-end-open gap portion 25a; c2: a width of second one-end-open gap portion 25b; d1: a length of first linear element portion 30a; d2: a length of second linear element portion 30b; e1: a width of first linear element portion 30a; e2: a width of second linear element portion 30b; f: a width of each-element-groundplate commonly short-circuiting conductive portion 26; g: a length of slot element portion 24; h: a width of feeding point forming conductor portion 23; i: a width of slot element portion 24; j: a width of a slot element-groundplate short-circuiting portion 27; and k: a length of opening portion 28. In addition, composite element feeding point 14 is formed by feeding point 14a (hereinafter, referred to as one feeding point 14a) of feeding point forming conductor portion 23 and feeding point 14b (hereinafter, referred to as the other feeding point 14b) of each-element-groundplate commonly short-circuiting conductive portion 26 or second linear element portion 30b in proximity of each-element-groundplate commonly short-circuiting conductive portion 26.

In broad-band plate antenna 12, length d1 of first linear element portion 30a and length d2 of second linear element portion 30b are odd multiple of approximately ¼ wavelength of the operation frequency. Length g of slot element portion 24 is integer multiple of approximately ½ wavelength of the operation frequency. Different operation frequencies are selected as the operation frequency for first linear element portion 30a, the operation frequency for second linear element portion 30b and the operation frequency for slot element portion 24 respectively, so that an element-integrated antenna adapted to three operation frequency bands can be obtained. In addition, adjacent operation frequencies are selected as the operation frequency for first linear element portion 30a, the operation frequency for second linear element portion 30b and the operation frequency for slot element portion 24 respectively, so that an element-integrated antenna adapted to continuous and broad operation frequency bands can be obtained.

In addition, in order to insulate between first conductor portion 31 and second linear element portion 30b, one or both of first conductor portion 31 and second linear element portion 30b is desirably covered by an insulator. A wire, a tape-like conductor, a conductor obtained by covering the former, or a coated cable implements first conductor portion 31. A connection point or a junction of first conductor portion 31 connecting first linear element portion 30a to feeding point forming conductor portion 23 is joined, for example, by soldering. A surface on which the feeding point of conductive substrate 10 is joined to a feeding cable, the feeding line, the coaxial cable, or the like may be flush with, or opposed to, a surface on which first conductor portion 31 is joined to the feeding point.

### Example 5

### According to Second Invention

According to Example 5 of the second invention, as shown in FIG. 13, there is provided broad-band plate antenna 12 in which a plurality of linear element portions and a slot element portion are integrally formed, wherein

first one-end-open gap portion 25a is provided in conductive substrate 10 in parallel to a part of the outer perimeter of conductive substrate 10, so as to form first linear element portion 30a between the part of the outer perimeter and first one-end-open gap portion 25a,

second one-end-open gap portion 25b is provided in conductive substrate 10 in parallel to first one-end-open gap portion 25a, so as to form second linear element portion 30b having a length longer than first linear element portion 30a between second one-end-open gap portion 25b and first one-end-open gap portion 25a,

a slot is provided in conductive substrate 10 in parallel to second one-end-open gap portion 25b, so as to form slot element portion 24,

opening portion 28 is provided in feeding point forming conductor portion 23 formed between second linear element portion 30b and slot element portion 24, and a conductive portion commonly short-circuiting each element to groundplate portion 21 is identified as each-element-groundplate commonly short-circuiting conductive portion 26,

one feeding point 14a connected to opposing ends of opening portion 28 is provided in feeding point forming conductor portion 23, and the other feeding point 14b is provided in a protruding portion formed at a connection portion of each-element-groundplate commonly short-circuiting conductive portion 26 and second linear element portion 30b (second conductor portion 32a protruding from element-groundplate short-circuiting connection portion),

first linear element portion 30a and feeding point forming conductor portion 23 are connected to each other by first conductor portion 31, and

remaining conductive substrate 10 other than the plurality of linear element portions, slot element portion 24, and feeding point forming conductor portion 23 is used as groundplate portion 21.

### Example 6

### According to Second Invention

According to Example 6 of the second invention, as shown in FIG. 14, there is provided broad-band plate antenna 12 in which a plurality of linear element portions and a slot element portion are integrally formed, wherein

first one-end-open gap portion 25a is provided in conductive substrate 10 in parallel to a part of the outer perimeter of conductive substrate 10, so as to form first linear element portion 30a between the part of the outer perimeter and first one-end-open gap portion 25a,

second one-end-open gap portion 25b is provided in conductive substrate 10 in parallel to first one-end-open gap portion 25a, so as to form second linear element portion 30b having a length longer than first linear element portion 30a between second one-end-open gap portion 25b and first one-end-open gap portion 25a,

a slot is provided in conductive substrate 10 in parallel to second one-end-open gap portion 25b, so as to form slot element portion 24,

opening portion 28 is provided in feeding point forming conductor portion 23 formed between second linear element portion 30b and slot element portion 24, and a conductive portion commonly short-circuiting each element to groundplate portion 21 is identified as each-element-groundplate commonly short-circuiting conductive portion 26,

one feeding point 14a connected to opposing ends of opening portion 28 is provided in feeding point forming conductor portion 23, and the other feeding point 14b is provided in a protruding portion of each-element-groundplate commonly short-circuiting conductive portion 26 (second conductor portion 32b protruding from the each-element-groundplate commonly short-circuiting conductive portion),

first linear element portion 30a and feeding point forming conductor portion 23 are connected to each other by first conductor portion 31, and

remaining conductive substrate 10 other than the plurality of linear element portions, slot element portion 24, and feeding point forming conductor portion 23 is used as groundplate portion 21.

### Example 7

### According to Second Invention

According to Example 7 of the second invention, as shown in FIG. 15, there is provided broad-band plate antenna 12 in which a plurality of linear element portions and a slot element portion are integrally formed, wherein

first one-end-open gap portion 25a is provided in conductive substrate 10 in parallel to a part of the outer perimeter of conductive substrate 10, so as to form first linear element portion 30a between the part of the outer perimeter and first one-end-open gap portion 25a,

second one-end-open gap portion 25b is provided in conductive substrate 10 in parallel to first one-end-open gap portion 25a, so as to form second linear element portion 30b having a length longer than first linear element portion 30a between second one-end-open gap portion 25b and first one-end-open gap portion 25a,

a slot is provided in conductive substrate 10 in parallel to second one-end-open gap portion 25b, so as to form slot element portion 24,

opening portion 28 is provided in feeding point forming conductor portion 23 formed between second linear element portion 30b and slot element portion 24, and a conductive portion commonly short-circuiting each element to groundplate portion 21 is identified as each-element-groundplate commonly short-circuiting conductive portion 26,

one feeding point 14a connected to opposing ends of opening portion 28 is provided in feeding point forming conductor portion 23, and the other feeding point 14b is provided in a protruding portion of second linear element portion 30b (second conductor portion 32c protruding from the second element portion),

first linear element portion 30a and feeding point forming conductor portion 23 are connected to each other by first conductor portion 31, and

remaining conductive substrate 10 other than the plurality of linear element portions, slot element portion 24, and feeding point forming conductor portion 23 is used as groundplate portion 21.

### Example 8

### According to Third Invention

According to Example 8 of the third invention, as shown in FIG. 16, there is provided a broad-band plate antenna in which a plurality of linear element portions are integrally formed according to the third invention, wherein a composite element portion is formed by first linear element portion 30a to third linear element portion 30c, second linear element portion 30b has a length longer than first linear element portion 30a, third linear element portion 30c has a length shorter than second linear element portion 30b, an area of a non-conductive portion between second linear element portion 30b and groundplate portion 21 is made larger, a conductive portion commonly short-circuiting each element to groundplate portion 21 is identified as each-element-groundplate commonly short-circuiting conductive portion 26, one feeding point 14a is provided in second linear element portion 30b, the other feeding point 14b is provided in third linear element portion 30c, and first linear element portion 30a and third linear element portion 30c are connected to each other by first conductor portion 31.

Broad-band plate antenna 20 in which a plurality of linear element portions are integrally formed shown in FIG. 16 is structured in the following manner.

(1) First one-end-open non-conductive surface 25a is provided in conductive substrate 10 in parallel to a part of the outer perimeter of conductive substrate 10, so as to form first linear element portion 30a between the part of the outer perimeter and first one-end-open non-conductive surface 25a,

(2) second one-end-open non-conductive surface 25b is provided in conductive substrate 10 in parallel to first one-end-open non-conductive surface 25a, so as to form second linear element portion 30b having a length longer than first linear element portion 30a between second one-end-open non-conductive surface 25b and first one-end-open non-conductive surface 25a,

(3) third one-end-open gap portion 25c is provided in the conductive substrate in parallel to second one-end-open non-conductive surface 25b, so as to form third linear element portion 30c having a length shorter than second linear element portion 30b between third one-end-open non-conductive surface 25c and second one-end-open non-conductive surface 25b, an area of second linear element portion 30b and an area of a non-conductive portion between second linear element portion 30b and groundplate portion 21 are made larger, and a conductive portion commonly short-circuiting each element to the groundplate portion is identified as each-element-groundplate commonly short-circuiting conductive portion 26,

(4) one feeding point 14a is provided in the vicinity of each-element-groundplate commonly short-circuiting conductive portion 26 of second linear element portion 30b,

(5) the other feeding point 14b is provided in the vicinity of each-element-groundplate commonly short-circuiting conductive portion 26 of third linear element portion 30c, and

(6) an area in the vicinity of each-element-groundplate commonly short-circuiting conductive portion 26 of first linear element portion 30a and an area in the vicinity of each-element-groundplate commonly short-circuiting conductive portion 26 of third linear element portion 30c are connected to each other by first conductor portion 31.

In FIG. 16, broad-band plate antenna 20 in which a plurality of linear element portions are integrally formed, wherein one-end-open gap portion 25 and second linear element portion 30b are formed by using a conductor for conductive substrate 10 and cutting and removing the conductor, is structured in the following manner.

(1) First one-end-open gap portion 25a is provided in conductive substrate 10 in parallel to a part of the outer perimeter of conductive substrate 10, so as to form first linear element portion 30a between the part of the outer perimeter and first one-end-open gap portion 25a,

(2) second one-end-open gap portion 25b is provided in conductive substrate 10 in parallel to first one-end-open gap portion 25a, so as to form second linear element portion 30b having a length longer than first linear element portion 30a between second one-end-open gap portion 25b and first one-end-open gap portion 25a,

(3) third one-end-open gap portion 25c is provided in the conductive substrate in parallel to second one-end-open gap portion 25b, so as to form third linear element portion 30c having a length shorter than second linear element portion 30b between third one-end-open gap portion 25c and second one-end-open non-conductive surface 25b, an area of second linear element portion 30b and an area of a gap portion between second linear element portion 30b and groundplate portion 21 are made larger, and a conductive portion commonly short-circuiting each element to the groundplate portion is identified as each-element-groundplate commonly short-circuiting conductive portion 26,

(4) one feeding point 14a is provided in the vicinity of each-element-groundplate commonly short-circuiting conductive portion 26 of second linear element portion 30b,

(5) the other feeding point 14b is provided in the vicinity of each-element-groundplate commonly short-circuiting conductive portion 26 of third linear element portion 30c, and

(6) an area in the vicinity of each-element-groundplate commonly short-circuiting conductive portion 26 of first linear element portion 30a and an area in the vicinity of each-element-groundplate commonly short-circuiting conductive portion 26 of third linear element portion 30c are connected to each other by first conductor portion 31.

### Example 9

### According to Third Invention)

According to Example 9 of the third invention, as shown in FIG. 1, there is provided a broad-band plate antenna in which a plurality of linear element portions are integrally formed according to the third invention, wherein a composite element portion is formed by first linear element portion 30a to third linear element portion 30c, second linear element portion 30b has a length longer than first linear element portion 30a and third linear element portion 30c, an area of second linear element portion 30b is made larger in a direction of first linear element portion 30a, third linear element portion 30c has a length shorter than second linear element portion 30d of which area has been made larger, an area of a non-conductive portion between second linear element portion 30b and groundplate portion 21 is made larger, a conductive portion commonly short-circuiting each element to groundplate portion 21 is identified as each-element-groundplate commonly short-circuiting conductive portion 26, one feeding point 14a is provided in second linear element portion 30b, the other feeding point 14b is provided in third linear element portion 30c, and first linear element portion 30a and third linear element portion 30c are connected to each other by first conductor portion 31.

Broad-band plate antenna 20 in which a plurality of linear element portions are integrally formed shown in FIG. 1 is structured in the following manner.

(1) First one-end-open non-conductive surface 25a is provided in conductive substrate 10 in parallel to a part of the outer perimeter of conductive substrate 10, so as to form first linear element portion 30a between the part of the outer perimeter and first one-end-open non-conductive surface 25a,

(2) second one-end-open non-conductive surface 25b is provided in conductive substrate 10 in parallel to first one-end-open non-conductive surface 25a, so as to form second linear element portion 30c having a length longer than first linear element portion 30a and an area made larger in a direction of first linear element portion 30a between second one-end-open non-conductive surface 25b and first one-end-open non-conductive surface 25a,

(3) third one-end-open gap portion 25c is provided in the conductive substrate in parallel to second one-end-open non-conductive surface 25b, so as to form third linear element portion 30c having a length shorter than second linear element portion 30b between third one-end-open gap portion 25c and second one-end-open non-conductive surface 25b, and an area of a non-conductive portion between second linear element portion 30b and groundplate portion 21 is made larger, and

a conductive portion commonly short-circuiting each element to groundplate portion 21 is identified as each-element-groundplate commonly short-circuiting conductive portion 26,

(4) one feeding point 14a is provided in the vicinity of each-element-groundplate commonly short-circuiting conductive portion 26 of second linear element portion 30d,

(5) the other feeding point 14b is provided in the vicinity of each-element-groundplate commonly short-circuiting conductive portion 26 of third linear element portion 30c, and

(6) an area in the vicinity of each-element-groundplate commonly short-circuiting conductive portion 26 of first linear element portion 30a and an area in the vicinity of each-element-groundplate commonly short-circuiting conductive portion 26 of third linear element portion 30c are connected to each other by first conductor portion 31.

In FIG. 1, broad-band plate antenna 20 in which a plurality of linear-element portions are integrally formed, wherein one-end-open gap portion 25 and each linear element portion 30 are formed by using a conductor for conductive substrate 10 and cutting and removing the conductor, is structured in the following manner.

(1) First one-end-open gap portion 25a is provided in conductive substrate 10 in parallel to a part of the outer perimeter of conductive substrate 10, so as to form first linear element portion 30a between the part of the outer perimeter and first one-end-open gap portion 25a,

(2) second one-end-open gap portion 25b is provided in conductive substrate 10 in parallel to first one-end-open gap portion 25a, so as to form second linear element portion 30d having a length longer than first linear element portion 30a and an area made larger in a direction of first linear element portion 30a between second one-end-open gap portion 25b and first one-end-open gap portion 25a,

(3) third one-end-open gap portion 25c is provided in the conductive substrate in parallel to second one-end-open gap portion 25b, so as to form third linear element portion 30c having a length shorter than second linear element portion 30b between third one-end-open gap portion 25c and second one-end-open gap portion 25b, an area of a gap portion between second linear element portion 30b and groundplate portion 21 is made larger, and a conductive portion commonly short-circuiting each element to groundplate portion 21 is identified as each-element-groundplate commonly short-circuiting conductive portion 26,

(4) one feeding point 14a is provided in the vicinity of each-element-groundplate commonly short-circuiting conductive portion 26 of second linear element portion 30d,

(5) the other feeding point 14b is provided in the vicinity of each-element-groundplate commonly short-circuiting conductive portion 26 of third linear element portion 30c, and

(6) an area in the vicinity of each-element-groundplate commonly short-circuiting conductive portion 26 of first linear element portion 30a and an area in the vicinity of each-element-groundplate commonly short-circuiting conductive portion 26 of third linear element portion 30c are connected to each other by first conductor portion 31.

### Example 10

### According to Third Invention

According to Example 10 of the third invention, as shown in FIG. 17, there is provided a broad-band plate antenna in which a plurality of linear element portions are integrally formed according to the third invention, wherein a composite element portion is formed by first linear element portion 30a to third linear element portion 30c, second linear element portion 30b has a length longer than first linear element portion 30a and third linear element portion 30c, third linear element portion 30c has a length shorter than a second linear element portion 30e of which area has been made larger, an area of a non-conductive portion between second linear element portion 30b and groundplate portion 21 is made larger, a conductive portion commonly short-circuiting each element to groundplate portion 21 is identified as each-element-groundplate commonly short-circuiting conductive portion 26, one feeding point 14a is provided in second linear element portion 30b, the other feeding point 14b is provided in third linear element portion 30c, and first linear element portion 30a and third linear element portion 30c are connected to each other by first conductor portion 31.

Broad-band plate antenna 20 in which a plurality of linear element portions are integrally formed shown in FIG. 17 is structured in the following manner.

(1) First one-end-open non-conductive surface 25a is provided in conductive substrate 10 in parallel to a part of the outer perimeter of conductive substrate 10, so as to form first linear element portion 30a between the part of the outer perimeter and first one-end-open non-conductive surface 25a,

(2) second one-end-open non-conductive surface 25b is provided in conductive substrate 10 in parallel to first one-end-open non-conductive surface 25a, so as to form second linear element portion 30e having a length longer than first linear element portion 30a and third linear element portion 30c and an area made larger in a direction of first linear element portion 30a and in a direction of third linear element portion 30c between second one-end-open non-conductive surface 25b and first one-end-open non-conductive surface 25a,

(3) third linear element portion 30c is formed in parallel to second one-end-open non-conductive surface 25b, an area of a non-conductive portion between second linear element portion 30b and groundplate portion 21 is made larger, and a conductive portion commonly short-circuiting each element to groundplate portion 21 is identified as each-element-groundplate commonly short-circuiting conductive portion 26,

(4) one feeding point 14a is provided in the vicinity of each-element-groundplate commonly short-circuiting conductive portion 26 of second linear element portion 30e,

(5) the other feeding point 14b is provided in the vicinity of each-element-groundplate commonly short-circuiting conductive portion 26 of third linear element portion 30c, and

(6) an area in the vicinity of each-element-groundplate commonly short-circuiting conductive portion 26 of first linear element portion 30a and an area in the vicinity of each-element-groundplate commonly short-circuiting conductive portion 26 of third linear element portion 30c are connected to each other by first conductor portion 31.

In FIG. 17, broad-band plate antenna 20 in which a plurality of linear element portions are integrally formed, wherein one-end-open gap portion 25 and each linear element portion 30 are formed by using a conductor for conductive substrate 10 and cutting and removing the conductor, is structured in the following manner.

(1) First one-end-open gap portion 25a is provided in conductive substrate 10 in parallel to a part of the outer perimeter of conductive substrate 10, so as to form first linear element portion 30a between the part of the outer perimeter and first one-end-open gap portion 25a,

(2) second one-end-open gap portion 25b is provided in conductive substrate 10 in parallel to first one-end-open gap portion 25a, so as to form second linear element portion 30e having a length longer than first linear element portion 30a and third linear element portion 30c and an area made larger in a direction of first linear element portion 30a and in a direction of third linear element portion 30c between second one-end-open gap portion 25b and first one-end-open gap portion 25a,

(3) third linear element portion 30c is formed in parallel to second one-end-open gap portion 25b, an area of a gap portion between second linear element portion 30b and groundplate portion 21 is made larger, and a conductive portion commonly short-circuiting each element to groundplate portion 21 is identified as each-element-groundplate commonly short-circuiting conductive portion 26,

(4) one feeding point 14a is provided in the vicinity of each-element-groundplate commonly short-circuiting conductive portion 26 of second linear element portion 30e,

(5) the other feeding point 14b is provided in the vicinity of each-element-groundplate commonly short-circuiting conductive portion 26 of third linear element portion 30c, and

(6) an area in the vicinity of each-element-groundplate commonly short-circuiting conductive portion 26 of first linear element portion 30a and an area in the vicinity of each-element-groundplate commonly short-circuiting conductive portion 26 of third linear element portion 30c are connected to each other by first conductor portion 31.

### Example 11

### According to Third Invention

According to Example 11 of the third invention, as shown in FIG. 18, there is provided a broad-band plate antenna in which a plurality of linear element portions are integrally formed, in the plate antenna including conductive substrate 10 forming a composite element portion and groundplate portion 21, wherein

first one-end-open non-conductive surface 25a is provided in conductive substrate 10 in parallel to a part of the outer perimeter of conductive substrate 10, so as to form first linear element portion 30a between the part of the outer perimeter and first one-end-open non-conductive surface 25a,

Nth one-end-open non-conductive surface 25a to Nth one-end-open non-conductive surface 25n are provided in conductive substrate 10 in parallel to first one-end-open non-conductive surface 25a, so as to form second linear element portion 30b to Nth linear element portion 30n between second one-end-open non-conductive surface 25b and Nth one-end-open non-conductive surface 25n, (N−1)th linear element portion 30n-1 second closest to groundplate portion 21 has a length longer than (N−2)th linear element portion 30n−2 third closest to groundplate portion 21 and Nth linear element portion 30n closest to groundplate portion 21, an area of (N−1)th linear element portion 30n−1 is made larger in a direction of the (N−2)th linear element portion or in a direction of the Nth linear element portion or in the direction of the (N−2)th linear element portion and the direction of the Nth linear element portion, and an area of a non-conductive portion between (N−1)th linear element portion 30n−1 and groundplate portion 21 is made larger,

a conductive portion commonly short-circuiting each element to groundplate portion 21 is identified as each-element-groundplate commonly short-circuiting conductive portion 26,

one feeding point 14a is provided in the vicinity of each-element-groundplate commonly short-circuiting conductive portion 26 of (N−1)th linear element portion 30n−1,

the other feeding point 14b is provided in the vicinity of each-element-groundplate commonly short-circuiting conductive portion 26 of Nth linear element portion 30n, and

an area in the vicinity of each-element-groundplate commonly short-circuiting conductive portion 26 of (N−2)th linear element portion 30n−2 and an area in the vicinity of each-element-groundplate commonly short-circuiting conductive portion 26 of Nth linear element portion 30n are connected to each other by first conductor portion 31.

Broad-band plate antenna 20 in which a plurality of linear element portions are integrally formed shown in FIG. 18 is structured in the following manner.

(1) First one-end-open non-conductive surface 25a is provided in conductive substrate 10 in parallel to a part of the outer perimeter of conductive substrate 10, so as to form first linear element portion 30a between the part of the outer perimeter and first one-end-open non-conductive surface 25a,

(2) second one-end-open non-conductive surface 25b is provided in conductive substrate 10 in parallel to first one-end-open non-conductive surface 25a, so as to form second linear element portion 30b to Nth linear element portion 30n between first one-end-open non-conductive surface 25a and Nth linear element portion 30n,

(3) (N−1)th linear element portion 30n-1 second closest to groundplate portion 21 has a length longer than (N−2)th linear element portion 30n−2 third closest to groundplate portion 21 and Nth linear element portion 30n closest to groundplate portion 21, an area of (N−1)th linear element portion 30n−1 is made larger (a) in a direction of (N−2)th linear element portion 30n−2 or (b) in a direction of Nth linear element portion 30n or (c) in the direction of (N−2)th linear element portion 30n−2 and the direction of Nth linear element portion 30n, an area of a non-conductive portion between (N−1)th linear element portion 30n−1 and groundplate portion 21 is made larger, and a conductive portion commonly short-circuiting each element to groundplate portion 21 is identified as each-element-groundplate commonly short-circuiting conductive portion 26,

(4) one feeding point 14a is provided in the vicinity of each-element-groundplate commonly short-circuiting conductive portion 26 of Nth linear element portion 30n closest to groundplate portion 21,

(5) the other feeding point 14b is provided in the vicinity of each-element-groundplate commonly short-circuiting conductive portion 26 of (N−1)th linear element portion 30n-1 second closest to groundplate portion 21, and

(6) an area in the vicinity of each-element-groundplate commonly short-circuiting conductive portion 26 of (N−2)th linear element portion 30n−2 and an area in the vicinity of each-element-groundplate commonly short-circuiting conductive portion 26 of Nth linear element portion 30n closest to groundplate portion 21 are connected to each other by first conductor portion 31.

In FIG. 18, broad-band plate antenna 20 in which a plurality of linear element portions are integrally formed, wherein one-end-open gap portion 25 and each linear element portion 30 are formed by using a conductor for conductive substrate 10 and cutting and removing the conductor, is structured in the following manner.

(1) First one-end-open gap portion 25a is provided in conductive substrate 10 in parallel to a part of the outer perimeter of conductive substrate 10, so as to form first linear element portion 30a between the part of the outer perimeter and first one-end-open gap portion 25a,

(2) second one-end-open gap portion 25b to Nth one-end-open gap portion 25n are provided in conductive substrate 10 in parallel to first one-end-open gap portion 25a, so as to form second linear element portion 30b to Nth linear element portion 30n between second one-end-open gap portion 25b and Nth one-end-open gap portion 25n,

(3) (N−1)th linear element portion 30n-1 second closest to groundplate portion 21 has a length longer than (N−2)th linear element portion 30n−2 third closest to groundplate portion 21 and Nth linear element portion 30n closest to groundplate portion 21, an area of (N−1)th linear element portion 30n−1 is made larger (a) in a direction of (N−2)th linear element portion 30n−2 or (b) in a direction of Nth linear element portion 30n or (c) in the direction of (N−2)th linear element portion 30n−2 and the direction of Nth linear element portion 30n, an area of a gap portion between (N−1)th linear element portion 30n−1 and groundplate portion 21 is made larger, and a conductive portion commonly short-circuiting each element to groundplate portion 21 is identified as each-element-groundplate commonly short-circuiting conductive portion 26,

(3) one feeding point 14a is provided in the vicinity of each-element-groundplate commonly short-circuiting conductive portion 26 of Nth linear element portion 30n closest to groundplate portion 21,

(4) the other feeding point 14b is provided in the vicinity of each-element-groundplate commonly short-circuiting conductive portion 26 of (N−1)th linear element portion 30n-1 second closest to groundplate portion 21, and

(5) an area in the vicinity of each-element-groundplate commonly short-circuiting conductive portion 26 of (N−2)th linear element portion 30n−2 and an area in the vicinity of each-element-groundplate commonly short-circuiting conductive portion 26 of Nth linear element portion3 on closest to groundplate portion 21 are connected to each other by first conductor portion 31.

[Effect of Third Invention]

An effect of the third invention will be described with reference to FIG. 19. FIG. 19 illustrates a reflection property of the broad-band plate antenna in which a plurality of linear element portions are integrally formed according to the third invention shown in FIG. 1, in which the abscissa represents an operation frequency [GHz] input/output to the feeding point of broad-band plate antenna 20 in which a plurality of linear element portions are integrally formed, while the ordinate represents reflection loss (return loss) [dB] specified by a shape of an antenna for each frequency, similarly to FIG. 12 above.

In FIG. 19, a solid line S3 represents a reflection property of broad-band plate antenna 20 in which a plurality of linear element portions are integrally formed according to Example 9 of the third invention shown in FIG. 1. A dashed line S2 represents a reflection property of the broad-band plate antenna in which a plurality of linear element portions and a slot element portion are integrally formed according to Example 4 of the second invention shown in FIG. 13. In the following, description will be given based on comparison of the reflection property of the third invention shown in FIG. 1 with the reflection property of the second invention shown in FIG. 13.

(a) As in FIG. 12 shown above, property S3a forming reflection property S3 is obtained by contribution mainly of second linear element portion 22b of the integral broad-band plate antenna shown in FIG. 16. Property S3bc is the reflection property obtained by contribution mainly of first linear element portion 22a and third linear element portion 22c.

Property S3bc is brought closer to the operation frequency of first linear element portion 22a and third linear element portion 22, so as to achieve an operation band broader than the total of the individual operation bands, as in FIG. 12 shown above.

(b) In addition, in FIG. 19, dashed line S2 represents a reflection property of broad-band plate antenna 12 in which a plurality of linear element portions and a slot element portion are integrally formed according to Example 4 of the second invention shown in FIG. 13.

As in FIG. 12 shown above, property S2a is obtained by contribution mainly of second linear element portion 22b of antenna 12 shown in FIG. 13, while property S2bc is the reflection property obtained by contribution mainly of first linear element portion 22a and slot element portion 24.

Property S2bc is brought closer to the operation frequency of first linear element portion 22a and third linear element portion 22c, so as to achieve an operation band broader than the total of the individual operation bands, as in FIG. 12 shown above.

(c) The operation band can similarly be broadened also in other Examples 6 and 7 and the like according to the second invention shown in FIGS. 14, 15 and their modifications.

As described previously, in Examples 4 to 6 shown in FIGS. 13 to 15 respectively, the operation band of property S2a is narrower than that of property S2bc in FIG. 19. Consequently, when length y1 of the composite element portion shown in FIGS. 13 to 15 to be stored in a personal computer housing is to be shortened, the operation band of property S2a is further narrowed and the operation band necessary for the operation may not be obtained, even if the operation band of property S2bc is sufficient.

In such a case, in Example 8 according to the third invention shown in FIG. 16, as compared with Examples 4 to 6 according to the second invention, an area of a gap between second linear element portion 22b and groundplate portion 21 is made larger, so that the operation band of property S3bc becomes broader than that of property S2bc, and length y1 of the composite element portion can further be shortened.

The broad-band plate antenna according to the first invention to the third invention described above can operate as a multiband antenna adapted to three or more different operation frequencies.

### INDUSTRIAL APPLICABILITY

As the present invention is practically useful in each embodiment as below, its industrial applicability is supported.

The broad-band plate antenna according to the first invention is highly industrially applicable, because it is suitable for a portable electronic apparatus that can be adapted to broad-band and multiband and can obtain originally-intended directivity of a signal from an antenna without increase in cost and restriction on a dimension, a shape, design, or the like of the portable electronic apparatus due to a housing space.

The broad-band plate antenna according to the second invention is highly industrially applicable, because it is capable of sufficiently exciting first linear element portion 30a even if first linear element portion 30a is shorter than second linear element portion 30b so that influence by a housing or the like is not exerted locally on a specific frequency, in addition to attaining the effect of the first invention.

The broad-band plate antenna in which a plurality of linear element portions are integrally formed according to the third invention is highly industrially applicable, because it is capable of achieving a broader operation band of the second linear element portion by increasing an area of second linear element portion 30b and an area of a gap portion between second linear element portion 30b and groundplate portion 21, in addition to attaining the effect of the first invention and the second invention.

1. A broad-band plate antenna in which a single linear element portion and a slot element portion are integrally formed; wherein
a one-end-open non-conductive surface is provided in a conductive substrate in parallel to a part of an outer perimeter of the conductive substrate, so as to form a linear element portion between the part of the outer perimeter and the one-end-open non-conductive surface,
a closed rectangle shaped non-conductive surface is provided in the conductive substrate in parallel to said one-end-open non-conductive surface, so as to form a slot element portion,
a non-conductive portion is provided in a feeding point forming conductive portion formed between the one-end-open non-conductive surface and the slot element portion, so as to use opposing ends of said non-conductive portion as a feeding point, and
remaining conductive portion of the conductive substrate other than said linear element portion, said slot element portion, and said feeding point forming conductive portion is used as a groundplate portion.

2. A broad-band plate antenna in which a single linear element portion and a slot element portion are integrally formed; wherein
a one-end-open gap portion is provided in a conductive substrate in parallel to a part of an outer perimeter of the conductive substrate, so as to form a linear element portion between the part of the outer perimeter and the one-end-open gap portion,
a slot is provided in the conductive substrate in parallel to said one-end-open gap portion, so as to form a slot element portion,
an opening portion is provided in a feeding point forming conductor portion formed between the one-end-open gap portion and the slot element portion, so as to use opposing ends of the opening portion as a feeding point, and
remaining conductive substrate other than said linear element portion, said slot element portion, and said feeding point forming conductor portion is used as a groundplate portion.

3. A broad-band plate antenna in which a plurality of linear element portions and a slot element portion are integrally formed; wherein
a first one-end-open non-conductive surface is provided in a conductive substrate in parallel to a part of an outer perimeter of the conductive substrate, so as to form a first linear element portion between the part of the outer perimeter and the first one-end-open non-conductive surface,
a second one-end-open non-conductive surface is provided in the conductive substrate in parallel to said first one-end-open non-conductive surface, so as to form a second linear element portion between said second one-end-open non-conductive surface and the first one-end-open non-conductive surface,
a closed rectangle shaped non-conductive surface is provided in the conductive substrate in parallel to said second one-end-open non-conductive surface, so as to form a slot element portion,
a non-conductive portion is provided in a feeding point forming conductive portion formed between the second linear element portion and the slot element portion, so as to use opposing ends of said non-conductive portion as a feeding point, and
remaining conductive substrate other than said plurality of linear element portions, said slot element portion, and said feeding point forming conductive portion is used as a groundplate portion.

4. A broad-band plate antenna in which a plurality of linear element portions and a slot element portion are integrally formed; wherein
a first one-end-open gap portion is provided in a conductive substrate in parallel to a part of an outer perimeter of the conductive substrate, so as to form a first linear element portion between the part of the outer perimeter and the first one-end-open gap portion,
a second one-end-open gap portion is provided in the conductive substrate in parallel to said first one-end-open gap portion, so as to form a second linear element portion between said second one-end-open gap portion and the first one-end-open gap portion,
a slot is provided in the conductive substrate in parallel to said second one-end-open gap portion, so as to form a slot element portion,
an opening portion is provided in a feeding point forming conductor portion formed between the second linear element portion and the slot element portion, so as to use opposing ends of said opening portion as a feeding point, and
remaining conductive substrate other than said plurality of linear element portions, said slot element portion, and said feeding point forming conductor portion is used as a groundplate portion.

5. A broad-band plate antenna in which a plurality of linear element portions and a slot element portion are integrally formed; wherein
a first one-end-open non-conductive surface is provided in a conductive substrate in parallel to a part of an outer perimeter of the conductive substrate, so as to form a first linear element portion between the part of the outer perimeter and the first one-end-open non-conductive surface,
a plurality of one-end-open non-conductive surfaces consisting of a second one-end-open non-conductive surface to an Nth one-end-open non-conductive surface are provided in the conductive substrate in parallel to said first one-end-open non-conductive surface, so as to form a plurality of linear element portions consisting of a second linear element portion to an Nth linear element portion between said one-end-open non-conductive surfaces,
a closed rectangle shaped non-conductive surface is provided in the conductive substrate in parallel to said Nth one-end-open non-conductive surface, so as to form a slot element portion,
a non-conductive portion is provided in a feeding point forming conductive portion formed between the Nth one-end-open non-conductive surface and the slot element portion, so as to use opposing ends of said non-conductive portion as a feeding point, and
remaining conductive substrate other than said plurality of linear element portions, said slot element portion, and said feeding point forming conductive portion is used as a groundplate portion.

6. A broad-band plate antenna in which a plurality of linear element portions and a slot element portion are integrally formed; wherein
a first one-end-open non-conductive surface is provided in a conductive substrate in parallel to a part of an outer perimeter of the conductive substrate, so as to form a first linear element portion of which length on an outer peripheral side of the conductive substrate is shorter, between the part of the outer perimeter and the first one-end-open non-conductive surface,
a second one-end-open non-conductive surface is provided in the conductive substrate in parallel to said first one-end-open non-conductive surface, so as to form a second linear element portion having a length longer than the first linear element portion between said second one-end-open non-conductive surface and the first one-end-open non-conductive surface,
a closed rectangle shaped non-conductive surface is provided in the conductive substrate in parallel to said second one-end-open non-conductive surface, so as to form a slot element portion,
a non-conductive portion is provided in a feeding point forming conductive portion formed between the second linear element portion and the slot element portion, so as to use opposing ends of said non-conductive portion as a feeding point,
the first linear element portion and a feeding point forming conductor portion are connected to each other by a first conductor portion, and
remaining conductive substrate other than said plurality of linear element portions, said slot element portion, and said feeding point forming conductive portion is used as a groundplate portion.

7. A broad-band plate antenna in which a plurality of linear element portions and a slot element portion are integrally formed; wherein
a first one-end-open gap portion is provided in a conductive substrate in parallel to a part of an outer perimeter of the conductive substrate, so as to form a first linear element portion between the part of the outer perimeter and the first one-end-open gap portion,
a second one-end-open gap portion is provided in the conductive substrate in parallel to said first one-end-open gap portion, so as to form a second linear element portion having a length longer than the first linear element portion between said second one-end-open gap portion and the first one-end-open gap portion,
a slot is provided in the conductive substrate in parallel to said second one-end-open gap portion, so as to form a slot element portion,
an opening portion is provided in a feeding point forming conductor portion formed between the second linear element portion and the slot element portion, so as to use opposing ends of said opening portion as a feeding point,
the first linear element portion and the feeding point forming conductor portion are connected to each other by a first conductor portion, and
remaining conductive substrate other than said plurality of linear element portions, said slot element portion, and said feeding point forming conductor portion is used as a groundplate portion.

8. A broad-band plate antenna in which a plurality of linear element portions and a slot element portion are integrally formed; wherein
a first one-end-open non-conductive surface is provided in a conductive substrate in parallel to a part of an outer perimeter of the conductive substrate, so as to form a first linear element portion between the part of the outer perimeter and the first one-end-open non-conductive surface,
a plurality of one-end-open non-conductive surfaces consisting of a second one-end-open non-conductive surface to an Nth one-end-open non-conductive surface are provided in the conductive substrate in parallel to said first one-end-open non-conductive surface, so as to form a plurality of linear element portions consisting of a second linear element portion to an Nth linear element portion, having a length longer than the first linear element portion, between said one-end-open non-conductive surfaces,
a closed rectangle shaped non-conductive surface is provided in the conductive substrate in parallel to said Nth one-end-open non-conductive surface, so as to form a slot element portion,
a non-conductive portion is provided in a feeding point forming conductive portion formed between the Nth one-end-open non-conductive surface and the slot element portion, so as to use opposing ends of said non-conductive portion as a feeding point,
the first linear element portion and a feeding point forming conductor portion are connected to each other by a first conductor portion, and
remaining conductive substrate other than said plurality of linear element portions, said slot element portion, and said feeding point forming conductive portion is used as a groundplate portion.

9. A broad-band plate antenna including a conductive substrate forming a composite element portion and a groundplate portion; wherein
a first one-end-open non-conductive surface is provided in the conductive substrate in parallel to a part of an outer perimeter of the conductive substrate, so as to form a first linear element portion between the part of the outer perimeter and the first one-end-open non-conductive surface,
a second one-end-open non-conductive surface is provided in the conductive substrate in parallel to said first one-end-open non-conductive surface, so as to form a second linear element portion having a length longer than the first linear element portion between said second one-end-open non-conductive surface and the first one-end-open non-conductive surface,
a third one-end-open non-conductive surface is provided in the conductive substrate in parallel to said second one-end-open non-conductive surface, so as to form a third linear element portion having a length shorter than the second linear element portion between said third one-end-open non-conductive surface and the second one-end-open non-conductive surface, and an area of a non-conductive portion between the second linear element portion and the groundplate portion is made larger,
a conductive portion commonly short-circuiting each element to the groundplate portion is identified as each-element-groundplate commonly short-circuiting conductive portion,
one feeding point is provided in vicinity of said each-element-groundplate commonly short-circuiting conductive portion of the second linear element portion,
the other feeding point is provided in vicinity of said each-element-groundplate commonly short-circuiting conductive portion of the third linear element portion, and
the first linear element portion and the third linear element portion are connected to each other by a first conductor portion.

10. A broad-band plate antenna including a conductive substrate forming a composite element portion and a groundplate portion; wherein
a first one-end-open gap portion is provided in the conductive substrate in parallel to a part of an outer perimeter of the conductive substrate, so as to form a first linear element portion between the part of the outer perimeter and the first one-end-open gap portion,
a second one-end-open gap portion is provided in the conductive substrate in parallel to said first one-end-open gap portion, so as to form a second linear element portion having a length longer than the first linear element portion between said second one-end-open gap portion and the first one-end-open gap portion,
a third one-end-open gap portion is provided in the conductive substrate in parallel to said second one-end-open gap portion, so as to form a third linear element portion having a length shorter than the second linear element portion between said third one-end-open gap portion and the second one-end-open gap portion, and an area of a gap portion between the second linear element portion and the groundplate portion is made larger,
a conductive portion commonly short-circuiting each element to the groundplate portion is identified as each-element-groundplate commonly short-circuiting conductive portion,
one feeding point is provided in vicinity of said each-element-groundplate commonly short-circuiting conductive portion of the second linear element portion,
the other feeding point is provided in vicinity of said each-element-groundplate commonly short-circuiting conductive portion of the third linear element portion, and
the first linear element portion and the third linear element portion are connected to each other by a first conductor portion.

11. A broad-band plate antenna including a conductive substrate forming a composite element portion and a groundplate portion; wherein
a first one-end-open non-conductive surface is provided in the conductive substrate in parallel to a part of an outer perimeter of the conductive substrate, so as to form a first linear element portion between the part of the outer perimeter and the first one-end-open non-conductive surface,
a second one-end-open non-conductive surface is provided in the conductive substrate in parallel to said first one-end-open non-conductive surface, so as to form a second linear element portion having a length longer than the first linear element portion and an area made larger in a direction of the first linear element portion between said second one-end-open non-conductive surface and the first one-end-open non-conductive surface,
a third one-end-open non-conductive surface is provided in the conductive substrate in parallel to said second one-end-open non-conductive surface, so as to form a third linear element portion having a length shorter than the second linear element portion between said third one-end-open non-conductive surface and the second one-end-open non-conductive surface, and an area of a non-conductive portion between the second linear element portion and the groundplate portion is made larger,
a conductive portion commonly short-circuiting each element to the groundplate portion is identified as each-element-groundplate commonly short-circuiting conductive portion,
one feeding point is provided in vicinity of said each-element-groundplate commonly short-circuiting conductive portion of the second linear element portion,
the other feeding point is provided in vicinity of said each-element-groundplate commonly short-circuiting conductive portion of the third linear element portion, and
the first linear element portion and the third linear element portion are connected to each other by a first conductor portion.

12. A broad-band plate antenna including a conductive substrate forming a composite element portion and a groundplate portion; wherein
a first one-end-open gap portion is provided in the conductive substrate in parallel to a part of an outer perimeter of the conductive substrate, so as to form a first linear element portion between the part of the outer perimeter and the first one-end-open gap portion,
a second one-end-open gap portion is provided in the conductive substrate in parallel to said first one-end-open gap portion, so as to form a second linear element portion having a length longer than the first linear element portion and an area made larger in a direction of the first linear element portion between said second one-end-open gap portion and the first one-end-open gap portion,
a third one-end-open gap portion is provided in the conductive substrate in parallel to said second one-end-open gap portion, so as to form a third linear element portion having a length shorter than the second linear element portion between said third one-end-open gap portion and the second one-end-open gap portion, and an area of a gap portion between the second linear element portion and the groundplate portion is made larger,
a conductive portion commonly short-circuiting each element to the groundplate portion is identified as each-element-groundplate commonly short-circuiting conductive portion,
one feeding point is provided in vicinity of said each-element-groundplate commonly short-circuiting conductive portion of the second linear element portion,
the other feeding point is provided in vicinity of said each-element-groundplate commonly short-circuiting conductive portion of the third linear element portion, and
the first linear element portion and the third linear element portion are connected to each other by a first conductor portion.

13. A broad-band plate antenna including a conductive substrate forming a composite element portion and a groundplate portion; wherein
a first one-end-open non-conductive surface is provided in the conductive substrate in parallel to a part of an outer perimeter of the conductive substrate, so as to form a first linear element portion between the part of the outer perimeter and the first one-end-open non-conductive surface,
a second one-end-open non-conductive surface is provided in the conductive substrate in parallel to said first one-end-open non-conductive surface, so as to form a second linear element portion having a length longer than the first linear element portion and an area made larger in a direction of the first linear element portion and in a direction opposite to the first linear element portion between said second one-end-open non-conductive surface and the first one-end-open non-conductive surface,
a third one-end-open non-conductive surface is provided in the conductive substrate in parallel to said second one-end-open non-conductive surface, so as to form a third linear element portion having a length shorter than the second linear element portion between said third one-end-open non-conductive surface and the second one-end-open non-conductive surface, an area of a non-conductive portion between the second linear element portion and the groundplate portion is made larger, and a conductive portion commonly short-circuiting each element to the groundplate portion is identified as each-element-groundplate commonly short-circuiting conductive portion,
one feeding point is provided in vicinity of said each-element-groundplate commonly short-circuiting conductive portion of the second linear element portion,
the other feeding point is provided in vicinity of said each-element-groundplate commonly short-circuiting conductive portion of the third linear element portion, and
the first linear element portion and the third linear element portion are connected to each other by a first conductor portion.

14. A broad-band plate antenna including a conductive substrate forming a composite element portion and a groundplate portion; wherein
a first one-end-open gap portion is provided in the conductive substrate in parallel to a part of an outer perimeter of the conductive substrate, so as to form a first linear element portion between the part of the outer perimeter and the first one-end-open gap portion,
a second one-end-open gap portion is provided in the conductive substrate in parallel to said first one-end-open gap portion, so as to form a second linear element portion having a length longer than the first linear element portion and an area made larger in a direction of the first linear element portion and in a direction opposite to the first linear element portion between said second one-end-open gap portion and the first one-end-open gap portion,
a third one-end-open gap portion is provided in the conductive substrate in parallel to said second one-end-open non-conductive surface, so as to form a third linear element portion having a length shorter than the second linear element portion between said third one-end-open gap portion and the second one-end-open gap portion, and an area of a gap portion between the second linear element portion and the groundplate portion is made larger,
a conductive portion commonly short-circuiting each element to the groundplate portion is identified as each-element-groundplate commonly short-circuiting conductive portion,
one feeding point is provided in vicinity of said each-element-groundplate commonly short-circuiting conductive portion of the second linear element portion,
the other feeding point is provided in vicinity of said each-element-groundplate commonly short-circuiting conductive portion of the third linear element portion, and
the first linear element portion and the third linear element portion are connected to each other by a first conductor portion.

15. A broad-band plate antenna including a conductive substrate forming a composite element portion and a groundplate portion; wherein
a first one-end-open non-conductive surface is provided in the conductive substrate in parallel to a part of an outer perimeter of the conductive substrate, so as to form a first linear element portion between the part of the outer perimeter and the first one-end-open non-conductive surface,
a second one-end-open non-conductive surface to an Nth one-end-open non-conductive surface are provided in the conductive substrate in parallel to said first one-end-open non-conductive surface, so as to form a second linear element portion to an Nth linear element portion between said second one-end-open non-conductive surface and the Nth one-end-open non-conductive surface, an (N−1)th linear element portion second closest to the groundplate portion has a length longer than an (N−2)th linear element portion third closest to the groundplate portion and an Nth linear element portion closest to the groundplate portion, an area of the (N−1)th linear element portion is made larger in a direction of the (N−2)th linear element portion or in a direction of the Nth linear element portion or in the direction of the (N−2)th linear element portion and the direction of the Nth linear element portion, and an area of a non-conductive portion between the (N−1)th linear element portion and the groundplate portion is made larger,
a conductive portion commonly short-circuiting each element to the groundplate portion is identified as each-element-groundplate commonly short-circuiting conductive portion,
one feeding point is provided in vicinity of said each-element-groundplate commonly short-circuiting conductive portion of the (N−1)th linear element portion,
the other feeding point is provided in vicinity of said each-element-groundplate commonly short-circuiting conductive portion of the Nth linear element portion, and
an area in vicinity of said each-element-groundplate commonly short-circuiting conductive portion of the (N−2)th linear element portion and an area in vicinity of said each-element-groundplate commonly short-circuiting conductive portion of the Nth linear element portion are connected to each other by a first conductor portion.

16. A broad-band plate antenna including a conductive substrate forming a composite element portion and a groundplate portion; wherein
a first one-end-open gap portion is provided in the conductive substrate in parallel to a part of an outer perimeter of the conductive substrate, so as to form a first linear element portion between the part of the outer perimeter and the first one-end-open gap portion,
a second one-end-open gap portion to an Nth one-end-open gap portion are provided in the conductive substrate in parallel to said first one-end-open gap portion, so as to form a second linear element portion to an Nth linear element portion between said second one-end-open gap portion and the Nth one-end-open gap portion, an (N−1)th linear element portion second closest to the groundplate portion has a length longer than an (N−2)th linear element portion third closest to the groundplate portion and an Nth linear element portion closest to the groundplate portion, an area of the (N−1)th linear element portion is made larger in a direction of the (N−2)th linear element portion or in a direction of the Nth linear element portion or in the direction of the (N−2)th linear element portion and the direction of the Nth linear element portion, and an area of a gap portion between the (N−1)th linear element portion and the groundplate portion is made larger,
a conductive portion commonly short-circuiting each element to the groundplate portion is identified as each-element-groundplate commonly short-circuiting conductive portion,
one feeding point is provided in vicinity of said each-element-groundplate commonly short-circuiting conductive portion of the (N−1)th linear element portion,
the other feeding point is provided in vicinity of said each-element-groundplate commonly short-circuiting conductive portion of the Nth linear element portion, and
an area in vicinity of said each-element-groundplate commonly short-circuiting conductive portion of the (N−2)th linear element portion and an area in vicinity of said each-element-groundplate commonly short-circuiting conductive portion of the Nth linear element portion are connected to each other by a first conductor portion.

17-19. (canceled)
